(19) United States
(12) Patent Application Publication
(10) Pub. No.: US 2025/0005882 A1
(43) Pub. Date: Jan. 2, 2025

(54) IMAGE CROPPING METHOD AND DEVICE, ELECTRONIC APPARATUS AND STORAGE MEDIUM

(71) Applicant: BEIJING ZITIAO NETWORK TECHNOLOGY CO., LTD., Beijing (CN)

(72) Inventor: Yunhao LIAO, Beijing (CN)

(21) Appl. No.: 18/755,505

(22) Filed: Jun. 26, 2024

(30) Foreign Application Priority Data
Jun. 28, 2023 (CN) 202310778863.0

(51) Int. Cl. G06V 10/25; G06T 3/40; G06T 7/62

(52) U.S. Cl. CPC G06V 10/25; G06T 3/40; G06T 7/62; G06T 2207/20132; G06V 2201/07

(57) ABSTRACT

An image cropping method and device, an electronic apparatus and a storage medium are provided. The method includes: acquiring an image to be cropped, and determining a target cropping object and image cropping parameters, the image cropping parameters including a first area proportion threshold of the target cropping object in a target cropping image; processing the image to be cropped, determining a bounding box in the image to be cropped, and determining box center point information of the bounding box; determining region center point information based on the box center point information, and determining a preliminary cropping region based on the region center point information and the first area proportion threshold; and determining a target cropping region based on a relative position relationship between the preliminary cropping region and the image to be cropped, and determining the target cropping image based on the target cropping region.

### CROSS-REFERENCE TO RELATED APPLICATION(S)

The present application claims priority of Chinese Patent Applications No. 202310778863.0 filed on Jun. 28, 2023, which is incorporated herein by reference in its entirety.

### TECHNICAL FIELD

Embodiments of the present disclosure relate to the technical field of image processing, in particular to an image cropping method and device, an electronic apparatus and a storage medium.

### BACKGROUND

In the context of image processing or video production, the application of image cropping is becoming increasingly widespread in various scenarios such as effect image processing, news presentation, and specific object display. The cropped image not only includes the content from the original image but also needs to meet the cropping requirements of different scenarios.

In the related art, it is usually needed to manually assess whether each image meets the requirements. For images that do not meet the requirements, to ensure the display effect of the cropped image, manual cropping is generally employed, with each image being cropped individually. This image cropping method requires a significant amount of manpower and time, especially when a large number of images need to be cropped. The cropping efficiency is low, and because it relies on manual operation, the display effect of the cropped images may not be consistent, impacting users' image processing experience.

### SUMMARY

The present disclosure provides an image processing method and device, an electronic apparatus, and a storage medium, so as to achieve cropping images from any source, and enhances the universality of image cropping functionality.

According to a first aspect, at least one embodiment of the present disclosure provides an image cropping method, including:

acquiring an image to be cropped, and determining a target cropping object in the image to be cropped and image cropping parameters corresponding to the image to be cropped, the image cropping parameters comprising a first area proportion threshold of the target cropping object in a target cropping image;

processing the image to be cropped, determining a bounding box corresponding to the target cropping object in the image to be cropped, and determining box center point information of the bounding box;

determining region center point information based on the box center point information, and determining a preliminary cropping region corresponding to the image to be cropped based on the region center point information and the first area proportion threshold; and

determining a target cropping region corresponding to the image to be cropped based on a relative position relationship between the preliminary cropping region and the image to be cropped, and determining the target cropping image corresponding to the image to be cropped based on the target cropping region.

According to a second aspect, at least one embodiment of the present disclosure provides an image cropping device, including:

an image cropping parameter determination module configured to acquire an image to be cropped, and determine a target cropping object in the image to be cropped and image cropping parameters corresponding to the image to be cropped, the image cropping parameters comprising a first area proportion threshold of the target cropping object in a target cropping image;

an object bounding box determination module configured to process the image to be cropped, determine a bounding box corresponding to the target cropping object in the image to be cropped, and determine box center point information of the bounding box;

a preliminary cropping region determination module configured to determine region center point information based on the box center point information, and determine a preliminary cropping region corresponding to the image to be cropped based on the region center point information and the first area proportion threshold; and

a target cropping image determination module configured to determine a target cropping region corresponding to the image to be cropped based on a relative position relationship between the preliminary cropping region and the image to be cropped, and determine the target cropping image corresponding to the image to be cropped based on the target cropping region.

According to a third aspect, at least one embodiment of the present disclosure provides an electronic apparatus, including:

one or more processors; and

a memory configured to store one or more programs, wherein

the one or more programs, when executed by the one or more processors, cause the one or more processors to implement the image cropping method according any one of the embodiments of the present disclosure.

According to a fourth aspect, at least one embodiment of the present disclosure provides a storage medium containing computer-executable instructions, wherein the computer-executable instructions, when executed by a computer processor, perform the image cropping method according any one of the embodiments of the present disclosure.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic, and the original and elements are not necessarily drawn to scale.

FIG. 1 is a flow diagram of an image cropping method according to an embodiment of the present disclosure;

FIG. 2 is a flow diagram of an image cropping method according to an embodiment of the present disclosure;

FIG. 3 is a flow diagram of an image cropping method according to an embodiment of the present disclosure;

FIG. 4 is a flow diagram of an image cropping method according to an embodiment of the present disclosure;

FIG. 5 is a flow diagram of an image cropping method according to an embodiment of the present disclosure;

FIG. 6 is a flow diagram of an image cropping method according to an embodiment of the present disclosure;

FIG. 7 is a structural diagram of an image cropping device according to an embodiment of the present disclosure; and

FIG. 8 is a structural diagram of an electronic apparatus according to an embodiment of the present disclosure.

### DETAILED DESCRIPTION

Hereinafter, embodiments of the present disclosure will be described in more detail with reference to the accompanying drawings. Although some embodiments of the present disclosure are shown in the drawings, it should be understood that the present disclosure can be implemented in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” refers to “at least one embodiment”; the term “another embodiment” refers to “at least one other embodiment”; the term “some embodiments” refers to “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a” and “a plurality” mentioned in the present disclosure are schematic rather than limiting, and those skilled in the art should understand that unless the context clearly indicates otherwise, they should be understood as “one or more”.

Names of messages or information exchanged among multiple devices in the embodiment of the present disclosure are only used for illustrative purposes, and are not used to limit the scope of these messages or information.

It can be understood that before using the technical solutions disclosed in several embodiments of the present disclosure, users should be informed of the types, scope of use and usage scenarios of personal information involved in the present disclosure in an appropriate way in accordance with relevant laws and regulations, and user authorization is required.

For example, in response to receiving a proactive request from a user, a prompt message is sent to the user, explicitly stating that the operation the user requested will necessitate acquiring and utilizing the user's personal information, so that the user can decide whether to provide personal information to software or hardware such as electronic apparatuses, applications, servers or storage media that perform the operation of the technical solution of the present disclosure according to the prompt message.

As an alternative and non-restrictive implementation mode, in response to receiving the proactive request from the user, the way to send the prompt message to the user can be, for example, in the form of a pop-up window, in which the prompt message can be presented in text. In addition, the pop-up window can also contain selection controls “agree” and “disagree” for the user to choose regarding the provision of personal information to electronic apparatuses.

It can be understood that the above notification and user authorization procedures are illustrative and do not limit the implementation modes of the present disclosure. Other methods that comply with relevant laws and regulations may also be applied in the implementation modes of the present disclosure.

It can be understood that the data involved in the present technical solution (including but not limited to the data itself, data acquisition or use) shall comply with the requirements of corresponding laws and regulations.

Before introducing the technical solution, illustrative examples of its application scenarios can be provided first. The technical solution can be applied to any scene involving image cropping. For instance, in scenarios requiring image cropping for effect image processing, such as stylized image processing, the artificial intelligence models employed during effect processing typically impose stringent constraints on the content of the input images. These constraints generally include requirements such as the effect action object not being too small, being a half-length portrait rather than a full-length one, and featuring only one person rather than multiple individuals. Failure to meet the predetermined image constraints may result in the inability to apply effects to the input image or produce an effect image with poor display quality. In such cases, based on the technical solution of the embodiments of the present disclosure, it is possible to acquire an image to be cropped, and determine a target cropping object in the image to be cropped and image cropping parameters, so that the image to be cropped can be processed based on the image cropping parameters and the target cropping object, ensuring that a resulting target cropping image includes the target cropping object while satisfying the image cropping parameters. This achieves preprocessing of the image before applying effects, ensuring that the cropped image meets the input image constraints corresponding to effect image processing, thereby enhancing the display quality of the effects.

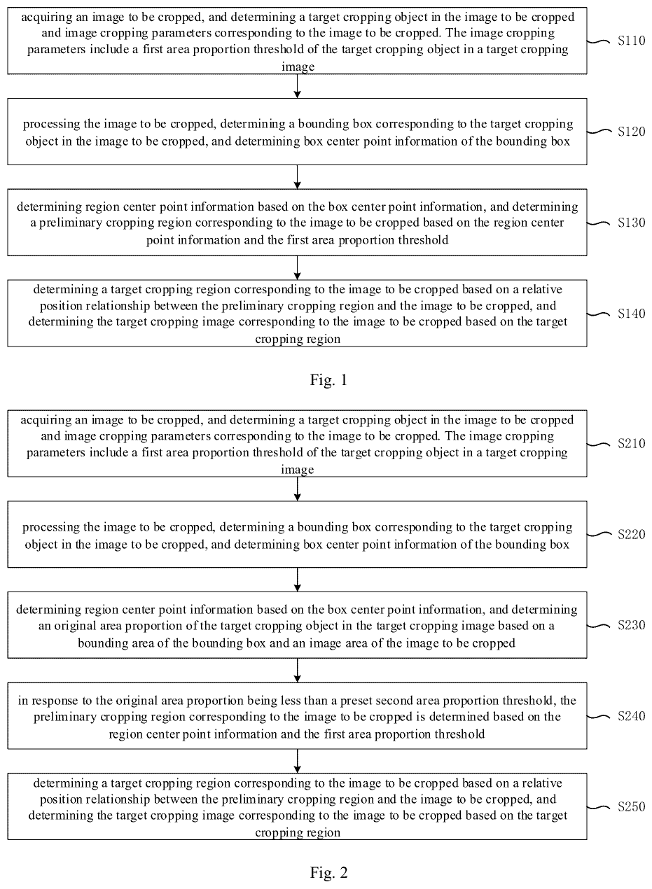

FIG. 1 is a flow diagram of an image cropping method according to an embodiment of the present disclosure. The embodiments of the present disclosure are applicable for scenarios where an acquired image is cropped in a scene with image cropping requirements. The method can be performed by an image cropping device. The apparatus can be realized by software and/or hardware, or alternatively, by an electronic apparatus, which can be a mobile terminal, a PC terminal or a server.

As illustrated by FIG. 1, the method provided by the present embodiment may include the following steps.

S110: acquiring an image to be cropped, and determining a target cropping object in the image to be cropped and image cropping parameters corresponding to the image to be cropped. Here, the image cropping parameters include a first area proportion threshold of the target cropping object in a target cropping image.

It should be noted that a device performing the image cropping method provided by the embodiments of the present disclosure can be integrated in application software supporting the image cropping function, and the software can be installed in an electronic apparatus. Alternatively, the electronic apparatus can be a mobile terminal or a PC terminal. The application software can be a type of software for image cropping, and the specific application software is not detailed here, as long as the image cropping can be realized. It can also be a specially developed application program integrated in software for image cropping, or it can be integrated in a corresponding page, and users can realize image cropping through the integrated page in the PC terminal.

Here, the image to be cropped can be an image that needs to be cropped. The image to be cropped can be a default template image, an image acquired based on a terminal device, an image obtained from a target storage space (such as an image library of application software or a local terminal photo album) in response to a trigger operation by a user, and an image uploaded from an external device. Alternatively, the terminal device can refer to an electronic apparatus with the image capturing function, such as cameras, smart phones and tablet computers.

In the practical application process, in response to a selection operation for a displayed image in an image cropping page of a terminal device, the selected image can be taken as the image to be cropped; alternatively, in response to detecting an image acquisition trigger operation, a camera in the terminal device can face an image acquisition region to capture the image to be cropped; alternatively, a plurality of images can be prestored in the early development stage, a page including at least one candidate image can be displayed based on a display interface of the terminal device in response to detecting the image acquisition trigger operation, users can select among the candidate images through a trigger operation, and in response to detecting a trigger operation for any candidate image, the candidate image can be taken as the image to be cropped; alternatively, in response to detecting the image acquisition trigger operation, an image uploaded by users to a current client in real time or periodically through an external device can be taken as the image to be cropped.

It should be noted that the number of images to be cropped can be one or more. Regardless of the quantity, the acquired images to be cropped can be processed by adopting the technical solution provided by the embodiments of the present disclosure.

In the present embodiment, the target cropping object may be an object that needs to be cropped from the image to be cropped. Alternatively, the target cropping object can be a person, a pet, a building, etc. In practical application, one or more objects can be included in the image to be cropped. In a case where the image to be cropped includes one object, the object can be taken as the image to be cropped. In a case where the image to be cropped includes a plurality of objects, one object can be determined from the plurality of objects based on preset cropping object determination logic, or a selection trigger operation by users, and the determined object can be taken as the target cropping object.

In the present embodiment, the image cropping parameters may be numerical values that are referred to when the image to be cropped is cropped. Alternatively, the image cropping parameters may include a first area proportion threshold of the target cropping object in the target cropping image. Here, the target cropping image can be an image obtained after the image to be cropped is cropped, and the image includes the target cropping object. The first area proportion threshold can be a preset value for limiting an image proportion of the target cropping object in the target cropping image.

It should be noted that the image cropping parameters may include other cropping parameters in addition to the first area proportion threshold, which is not specifically limited by the embodiments of the present disclosure.

In practical application, the first area proportion threshold of the target cropping object in the target cropping image, which is one of the image cropping parameters, can be associated with an object type corresponding to the target cropping object. Specifically, object types of various objects to be cropped can be determined in advance, and first area proportion thresholds corresponding to the object types can be set respectively. Further, the first area proportion threshold is associated with the object type of the object to be cropped, and the first area proportion threshold and a corresponding object type identifier are stored in a database of the terminal device in an associated manner. Further, in response to determining the target cropping object in the acquired image to be cropped, the object type of the target cropping object can be determined, and the corresponding first area proportion threshold can be retrieved from the database according to the object type.

Alternatively, the determining the image cropping parameters corresponding to the image to be cropped includes: acquiring a first area proportion threshold corresponding to the target cropping object based on target object parameters associated with the target cropping object.

The target object parameters include at least one of the number of a plurality of target cropping objects in the image to be cropped, an average value of area proportions of each of the plurality of target cropping objects in the image to be cropped, and distances between the plurality of target cropping objects.

In the present embodiment, the target object parameters may be parameters representing the attribute characteristics of the target cropping object in the image. The average value of area proportions of each of the plurality of target cropping objects in the image to be cropped can be the ratio between the sum of the area proportions of the plurality of target cropping objects in the image to be cropped and the number of the target cropping objects in the image to be cropped. The distances between the plurality of target cropping objects can be the distances between center points of the plurality of target cropping objects in the image to be cropped.

In practical application, different first area proportion thresholds can be set in advance according to different object parameters, and the set first area proportion thresholds can be stored in a parameter library of application software. Further, in response to determining the target cropping object in the image to be cropped, the target object parameters associated with the target cropping object can be determined according to the determined target cropping object. Then, according to the determined target object parameters, a first area proportion threshold corresponding to the target object parameters can be retrieved from the parameter library, and the first area proportion threshold can be used as the first area proportion threshold corresponding to the target cropping object. The advantage of this approach is that it improves the efficiency of determining the first area proportion threshold and the matching rate with the image to be cropped, thereby improving the display effect of the target cropping image.

Alternatively, in response to determining the target cropping object in the acquired image to be cropped, image data associated with the first area proportion threshold determination process can be acquired according to the image to be cropped. Further, the acquired image data are processed according to a pre-deployed algorithm, so that the first area proportion threshold of the target cropping object in the target cropping image can be determined.

S120: processing the image to be cropped, determining a bounding box corresponding to the target cropping object in the image to be cropped, and determining box center point information of the bounding box.

Here, the bounding box is a relatively simple closed space, and the space contains objects with complex shapes. Those skilled in the art should understand that the bounding box corresponding to any object can be determined according to a bounding box algorithm, which is an algorithm for finding the optimal enclosing space for a set of discrete points. The basic idea is to approximately replace complex geometric objects with large and simple geometric shapes (i.e., bounding boxes). Common bounding box algorithms include axis-aligned bounding box (AABB), bounding spheres, oriented bounding box (OBB), and fixed directions hulls (FDH). In the present embodiment, the AABB algorithm can be used to determine the bounding box corresponding to the target cropping object. The determined bounding box can be a smallest hexahedron containing the target cropping object, with edges parallel to the coordinate axes. In practical application, after obtaining the image to be cropped, an image coordinate system can be established with the top-left corner of the image to be cropped as the origin, the width of the image to be cropped as the X-axis, and the height of the image to be cropped as the Y-axis. Further, when determining the bounding box corresponding to the target cropping object in the image to be cropped, it is possible to determine a bounding box containing the target cropping object and having edges parallel to the coordinate axes of the image coordinate system corresponding to the image to be cropped based on the image coordinate system corresponding to the image to be cropped.

Here, the box center point information can be information representing the position of a bounding box center point. The box center point information can be expressed in any form, and alternatively, it can be the coordinates of the box center point of the bounding box.

In practical application, in response to determining the target cropping object in the acquired image to be cropped, the image to be cropped can be processed according to the bounding box algorithm to determine the bounding box corresponding to the target cropping object. Further, the box center point information of the bounding box can be determined according to corresponding size information of the determined bounding box.

It should be noted that the corresponding size information of the bounding box corresponding to the determined target cropping object can be normalized size information or non-normalized size information; accordingly, the box center point information of the bounding box can also be normalized information or non-normalized information, which is not specifically limited by the embodiments of the present disclosure.

S130: determining region center point information based on the box center point information, and determining a preliminary cropping region corresponding to the image to be cropped based on the region center point information and the first area proportion threshold.

Here, the region center point information can be the information that represents the center position of the preliminary cropping region in the image to be cropped. The region center point information can be expressed in any form, and alternatively, it can be region center point coordinate information. The preliminary cropping region can be preliminarily determined and not yet perfected. In practical application, before the image to be cropped is cropped, the preliminary cropping region can be adjusted, so as to crop the image to be cropped based on the adjusted preliminary cropping region.

In the practical application process, the box center point information as determined can be normalized information or non-normalized information. In order to facilitate the calculation of the subsequent cropping process, the region center point information is non-normalized information, that is, the region center point information needs to match the coordinate information of the image to be cropped. Therefore, there are two situations in terms of the determination of the region center point information according to the box center point information, which can be explained separately below.

In one situation, the determining region center point information based on the box center point information may include: in response to the box center point information matching the coordinate information of the image to be cropped, taking the box center point information as the region center point information.

In the present embodiment, the coordinate information of the image to be cropped may be the coordinate values of the image vertices of the image to be cropped in the constructed coordinate system. The box center point information matching the coordinate information of the image to be cropped can indicate that a coordinate system used to determine the box center point information and the coordinate system corresponding to the image to be cropped are the same coordinate system. It should be noted that the box center point information matching the coordinate information of the image to be cropped can also indicate that the box center point information is non-normalized information.

In practical application, the coordinate information of the image to be cropped can be determined in response to acquiring the image to be cropped. Further, after determining the box center point information of the bounding box, the box center point information as determined can be matched with the coordinate information of the image to be cropped. In response to the box center point information matching the coordinate information of the image to be cropped, the box center point information can be used as the region center point information.

In the other situation, the step of determining region center point information based on the box center point information may include: in response to the box center point information of the bounding box not matching the coordinate information of the image to be cropped, transforming coordinate information of the box center point information based on the coordinate information of the image to be cropped, and taking the coordinate information after transforming of the box center point information as the region center point information.

In the present embodiment, the box center point information not matching the coordinate information of the image to be cropped can be understood as the coordinate system used to determine the box center point information and the coordinate system corresponding to the image to be cropped being different coordinate systems, and can also be understood as the box center point information being normalized information.

In practical application, in response to the box center point information of the bounding box not matching the coordinate information of the image to be cropped, in order to facilitate the calculation of the subsequent cropping process, coordinate transformation can be performed on the box center point information according to the coordinate information of the image to be cropped. Specifically, the width value and height value of the image to be cropped can be determined according to the coordinate information of the image to be cropped, then the abscissa in the box center point information can be multiplied by the width value and the ordinate in the box center point information can be multiplied by the height value, and the box center point information obtained after multiplication can be used as the transformed box center point information. The transformed box center point information matches the coordinate information of the image to be cropped. Further, the transformed box center point information can be used as the region center point information.

It should be noted that in response to the box center point information not matching the coordinate information of the image to be cropped, the coordinate information of the bounding box also does not match the coordinate information of the image to be cropped. Therefore, while transforming the box center point information based on the coordinate information of the image to be cropped, the coordinate information of the bounding box can also be transformed based on the coordinate information of the image to be cropped. Specifically, after determining the width value and height value of the image to be cropped, the coordinate information corresponding to a left boundary of the bounding box and the coordinate information corresponding to a right boundary of the bounding box can be multiplied by the width value of the image to be cropped, and the coordinate information corresponding to an upper boundary of the bounding box and the coordinate information corresponding to a lower boundary of the bounding box can be multiplied by the height value of the image to be cropped, so that the bounding box obtained after multiplication can be used as the transformed bounding box.

Further, after the region center point information is determined, the preliminary cropping region corresponding to the image to be cropped can be determined based on the region center point information and the first area proportion threshold.

In the concrete implementation, the region center point information can be taken as the center point information of the preliminary cropping region, and the first area proportion threshold can be taken as the ratio between the area of the bounding box corresponding to the target cropping object and the area of the determined preliminary cropping region. Further, the preset image size corresponding to the target cropping image can be obtained. Then, in response to determining the coordinate information of the bounding box, the ratio between the area of the bounding box and the area of the preliminary cropping region, and the preset image size corresponding to the target cropping image, the width value and length value of the preliminary cropping region can be determined, so that the preliminary cropping region corresponding to the object to be cropped can be obtained.

It should be noted that the preset image size corresponding to the target cropping image can be a preset system default size value. Alternatively, in response to determining the first area proportion threshold and the region center point information, the determined first area proportion threshold and region center point information can be processed according to a pre-deployed region size determination algorithm, so as to obtain the preset image size corresponding to the target cropping image, which is not specifically limited in the embodiments of the disclosure.

In practical application, the image size corresponding to the target cropping image can be a preset and configurable size parameter. After acquiring the image to be cropped, the width value and height value of the target cropping image obtained by cropping the image to be cropped can be configured according to the image cropping requirements, or the aspect ratio can be configured, and the configured size parameter can be used as the target image size of the target cropping image. Meanwhile, the configured size parameter can be taken as one of the image cropping parameters corresponding to the image to be cropped. Further, the preliminary cropping region corresponding to the image to be cropped can be determined according to the region center point information, the first area proportion threshold and the target image size corresponding to the target cropping image.

In practical application, in response to the image cropping parameters including the target image aspect ratio corresponding to the target cropping image obtained by cropping the image to be cropped, the step of determining region center point information based on the box center point information, and determining a preliminary cropping region corresponding to the image to be cropped based on the region center point information and the first area proportion threshold includes: determining the region center point information based on the box center point information, and determining the preliminary cropping region corresponding to the image to be cropped based on the region center point information, the first area proportion threshold and the target image aspect ratio.

In the present embodiment, the target image aspect ratio can be the ratio between the image width and the image height of the target cropping image. For the target image aspect ratio corresponding to the target cropping image, which is one of the image cropping parameters, a plurality of image aspect ratios can be preset, and in response to detecting an editing trigger operation for the image aspect ratio, a plurality of candidate image aspect ratios can be displayed in a display interface, so that users can select from the displayed candidate image aspect ratios through a trigger operation. Further, in response to detecting a trigger operation for any candidate image aspect ratio, the candidate image aspect ratio can be taken as the target image aspect ratio.

Alternatively, in response to detecting the editing trigger operation for the image aspect ratio, users can customize the image aspect ratio, and in response to detecting an editing completion operation for the image aspect ratio, the configured image aspect ratio can be taken as the target image aspect ratio.

In practical application, in response to obtaining the image to be cropped, the target cropping object can be determined among one or more objects included in the image to be cropped, and each image cropping parameter which is referred to when the image to be cropped is cropped is also determined. Specifically, the first area proportion threshold of the target cropping object in the target cropping image and the target image aspect ratio corresponding to the target cropping image can be determined.

Further, in response to determining the region center point information, the first area proportion threshold and the target image aspect ratio, the width value and height value of the bounding box corresponding to the target cropping object can be determined according to the coordinate information of the bounding box, and the product of the width value and the height value is the area of the bounding box. Further, the first area proportion threshold can be taken as the ratio between the area of the bounding box and the product of the width value and height value of the preliminary cropping region, and the target image aspect ratio can be taken as the ratio between the width value and height value of the preliminary cropping region. Therefore, the width value and height value of the preliminary cropping region can be obtained.

For example, the process of determining the preliminary cropping region can be expressed based on the following equations:

$$\{ \begin{matrix}\frac{{w}_{a} ⋆ {h}_{a}}{{w}_{r} ⋆ {h}_{r}} = t \\ \frac{{w}_{r}}{{h}_{r}} = R\end{matrix}$$

The following can be derived through the simultaneous solution of the above equations:

$$\{ \begin{matrix}{h}_{r} = \sqrt{\frac{1.}{R} * {w}_{a} * {h}_{a} / t} \\ {w}_{r} = R * {h}_{r}\end{matrix}$$

where wₐ can represent the width value of the bounding box corresponding to the target cropping object; hₐ can represent the height value of the bounding box corresponding to the target cropping object; wᵣ can represent the width value of the preliminary cropping region; hᵣ can represent the height value of the preliminary cropping region; t can represent the first area proportion threshold; and R can represent the target image aspect ratio.

S140: determining a target cropping region corresponding to the image to be cropped based on a relative position relationship between the preliminary cropping region and the image to be cropped, and determining the target cropping image corresponding to the image to be cropped based on the target cropping region.

Here, the target cropping region can be a region as the cropping standard when the image to be cropped is cropped. The target cropping region can also be understood as a cropping frame corresponding to the image to be cropped, and the image to be cropped can be cropped according to the boundaries of the cropping frame. The relative position relationship between the preliminary cropping region and the image to be cropped can be understood as the relationship between the region position of the preliminary cropping region and the image position of the image to be cropped. Alternatively, the relative position relationship may include that the whole preliminary cropping region is located inside the image to be cropped, or at least part of the preliminary cropping region is not located inside the image to be cropped.

In the present embodiment, the target cropping image can be an image obtained by cropping the image to be cropped. The target cropping image can also be understood as the image to be cropped within the target cropping region.

In practical application, after determining the preliminary cropping region corresponding to the image to be cropped, the coordinate information of each pixel in the preliminary cropping region and the coordinate information of each pixel in the image to be cropped can be determined. Further, the coordinate information corresponding to the preliminary cropping region can be compared with the coordinate information corresponding to the image to be cropped, and the relative position relationship between the preliminary cropping region and the image to be cropped can be determined. Further, the preliminary cropping region can be processed according to the determined relative position relationship, and the target cropping region can be determined according to the processed preliminary cropping region. Thus, the image to be cropped can be processed according to the target cropping region, so as to obtain the target cropping image corresponding to the image to be cropped.

Alternatively, the determining the target cropping image corresponding to the image to be cropped based on the target cropping region includes: for each pixel in the target cropping region, performing sampling based on coordinate information of the pixel in the image to be cropped, and performing image rendering based on sampled pixel values, so as to obtain the target cropping image corresponding to the image to be cropped.

In the present embodiment, the coordinate information of the image to be cropped can be the coordinate information of each pixel in the image to be cropped.

In practical application, for each pixel in the target cropping region, the coordinate information of the pixel can be determined, and according to the coordinate information, the coordinate information of the image to be cropped is traversed, so as to determine the coordinate information matching the coordinate information of the pixel in the coordinate information of the image to be cropped. Further, a pixel value corresponding to the pixel can be determined according to the determined coordinate information.

It should be understood by those skilled in the art that when UVs are used as texture coordinate points residing on the vertices of a polygonal region, a two-dimensional texture coordinate system can be defined, which is referred to as UV texture space. In this space, U and V are utilized to define the coordinate axes, determining how a texture image is placed onto a two-dimensional plane.

Based on this, for each pixel in the target cropping region, sampling can be performed according to the position of the pixel in the UV texture space constructed from the image to be cropped. Further, the pixel value corresponding to the pixel can be determined.

In the present embodiment, in response to obtaining the pixel value corresponding to the pixel, the pixel value can be sent to a shader of a graphics processing unit (GPU), so that the target cropping region can be rendered based on the shader, thus obtaining the target cropping image corresponding to the image to be cropped.

According to the technical solution of the embodiments of the present disclosure, the image to be cropped is acquired, and the target cropping object in the image to be cropped and the image cropping parameters corresponding to the image to be cropped are determined, with the image cropping parameters including the first area proportion threshold of the target cropping object in the target cropping image, so that the cropping criteria referred to when the image to be cropped is cropped are accurately determined, laying a foundation for the subsequent cropping process. Then, the image to be cropped is processed, the bounding box corresponding to the target cropping object in the image to be cropped is determined, and the box center point information of the bounding box is determined, so as to accurately determine the position information and area proportion information of the target cropping object in the image to be cropped. Further, the region center point information is determined based on the box center point information, and the preliminary cropping region corresponding to the image to be cropped is determined based on the region center point information and the first area proportion threshold, achieving the effect of preliminarily determining an ideal cropping region centered on the target detection object while meeting the image cropping parameters. Finally, the target cropping region corresponding to the image to be cropped is determined based on the relative position relationship between the preliminary cropping region and the image to be cropped, and the target cropping image corresponding to the image to be cropped is determined based on the target cropping region. This addresses the technical issues, existing in the related art, of laborious and inefficient image cropping, low cropping efficiency, and inconsistent display effects of cropped images, enables cropping of images from any source, and enhances the universality of image cropping functionality. Additionally, it ensures the image cropping effect while meeting the cropping requirements.

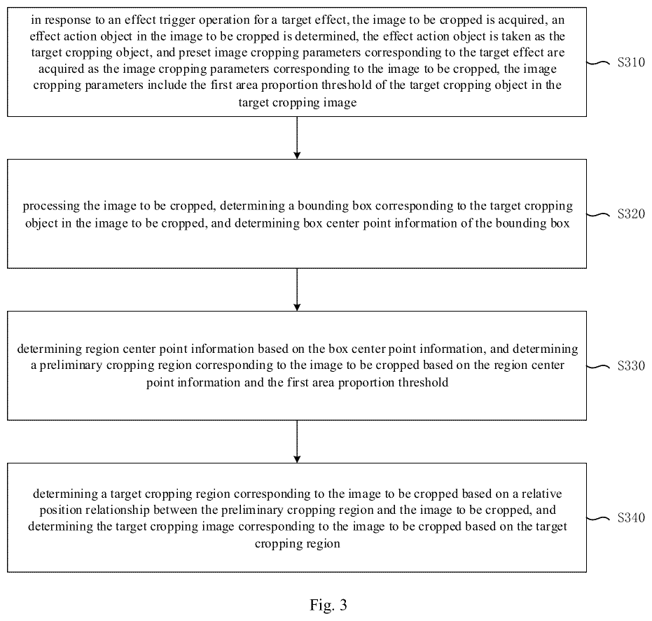

FIG. 2 is a flow diagram of an image cropping method according to an embodiment of the present disclosure. Based on the above embodiment, the technical solution of the present embodiment can determine an original area proportion of the target cropping object in the target cropping image, and determine the preliminary cropping region according to the region center point information, the first area proportion threshold and the target image aspect ratio in response to the original area proportion being less than a second area proportion threshold. Detailed implementation modes can be found in the description of the present embodiment. The same or similar technical features as those in the previous embodiments will not be repeated here.

As illustrated by FIG. 2, the method provided by the present embodiment may include the following steps.

S210: acquiring an image to be cropped, and determining a target cropping object in the image to be cropped and image cropping parameters corresponding to the image to be cropped. Here, the image cropping parameters include a first area proportion threshold of the target cropping object in a target cropping image.

S220: processing the image to be cropped, determining a bounding box corresponding to the target cropping object in the image to be cropped, and determining box center point information of the bounding box.

S230: determining region center point information based on the box center point information, and determining an original area proportion of the target cropping object in the target cropping image based on a bounding area of the bounding box and an image area of the image to be cropped.

The bounding area can be the area of the bounding box corresponding to the target cropping object in the image to be cropped. The bounding area can be the product of the width value and the height value of the bounding box. The original area proportion can be the ratio between the area occupied by the target cropping object in the image to the image area of the image to be cropped.

In practical application, after acquiring the image to be cropped, the image area of the image to be cropped can be determined according to the coordinate information of the image to be cropped. After determining the bounding box corresponding to the target cropping object, the bounding area of the bounding box can be determined according to the coordinate information of the bounding box. Further, the ratio between the bounding area and the image area can be determined, and this ratio can be taken as the original area proportion of the target cropping object in the image to be cropped.

S240: in response to the original area proportion being less than a preset second area proportion threshold, the preliminary cropping region corresponding to the image to be cropped is determined based on the region center point information and the first area proportion threshold.

In the present embodiment, the second area proportion threshold can be a preset area proportion threshold for determining whether cropping is needed. It should be noted that the first area proportion threshold and the second area proportion threshold may be the same or different values. In a case where the two proportion thresholds are different values, the first area proportion threshold can be greater than the second area proportion threshold.

In practical application, after obtaining the original area proportion, in order to determine whether the image to be cropped needs to be cropped, the original area proportion can be compared with the preset second area proportion threshold. The original area proportion being less than the second area proportion threshold indicates that the original area proportion does not meet the area proportion requirement of the target cropping object in the image, and the image to be cropped needs to be cropped. Further, the region center point information can be taken as the center point information of the preliminary cropping region, and the first area proportion threshold can be taken as the ratio between the area of the bounding box corresponding to the target cropping object and the area of the determined preliminary cropping region. Further, in response to determining the coordinate information of the bounding box and the ratio between the area of the bounding box and the area of the preliminary cropping region, the width value and length value of the preliminary cropping region can be determined, so that the preliminary cropping region corresponding to the object to be cropped can be obtained.

S250: determining a target cropping region corresponding to the image to be cropped based on a relative position relationship between the preliminary cropping region and the image to be cropped, and determining the target cropping image corresponding to the image to be cropped based on the target cropping region.

In practical application, the original area proportion being greater than or equal to the second area proportion threshold indicates that the area proportion of the target cropping object in the image to be cropped meets the object area proportion requirement. Therefore, the target cropping region can be determined according to the image to be cropped, and the target cropping image can be determined based on the target cropping region.

Alternatively, after determining an original area proportion of the target cropping object in the target cropping image based on a bounding area of the bounding box and an image area of the image to be cropped, the method further includes: in response to the original area proportion being greater than or equal to the second area proportion threshold, determining a target cropping region corresponding to the image to be cropped based on an original image aspect ratio of the image to be cropped and the target image aspect ratio, and determining a target cropping image corresponding to the image to be cropped based on the target cropping region.

In the present embodiment, the original image aspect ratio can be the ratio between the width value and the height value of the image to be cropped.

In practical application, the original area proportion being greater than or equal to the second area proportion threshold indicates that the area proportion of the target cropping object in the image to be cropped meets the preset area proportion requirement, and it is unnecessary to consider the area proportion of the target cropping object in the target cropping image. Further, the image to be cropped can be processed according to the target image aspect ratio, so that the image aspect ratio of the processed image to be cropped can meet the target image aspect ratio. Specifically, the original image aspect ratio of the image to be cropped can be determined. Then, the target cropping region of the image to be cropped can be determined according to the original image aspect ratio and the predetermined target image aspect ratio. Further, the target cropping image corresponding to the image to be cropped can be determined based on the target cropped region. The advantage of this approach is that the effect of determining the target cropping region according to the image aspect ratio under the condition that the area proportion of the target cropping object in the image to be cropped meets the cropping requirements is realized.

According to the technical solution of the embodiments of the present disclosure, the image to be cropped is acquired, and the target cropping object in the image to be cropped and the image cropping parameters corresponding to the image to be cropped are determined, with the image cropping parameters including the first area proportion threshold of the target cropping object in the target cropping image. Then, the image to be cropped is processed, the bounding box corresponding to the target cropping object in the image to be cropped is determined, and the box center point information of the bounding box is determined. Then, the region center point information is determined based on the box center point information, the original area proportion of the target cropping object in the image to be cropped is determined based on the bounding area of the bounding box and the image area of the image to be cropped, and the preliminary cropping region corresponding to the image to be cropped is determined based on the region center point information and the first area proportion threshold in response to the original area proportion being less than the preset second area proportion threshold. Finally, based on the relative position relationship between the preliminary cropping region and the image to be cropped, the target cropping region corresponding to the image to be cropped is determined, and the target cropping image corresponding to the image to be cropped is determined based on the target cropping region. In this way, the effect of determining the preliminary cropping region when the area proportion of the target cropping object in the image to be cropped does not meet the cropping requirements is achieved, and further, it is ensured that the target cropping image obtained after cropping meets the cropping requirements.

FIG. 3 is a flow diagram of an image cropping method according to an embodiment of the present disclosure. On the basis of the above embodiment, the technical solution of the present embodiment acquires the image to be cropped in response to an effect trigger operation for a target effect, and determines the target cropping object in the image to be cropped and the image cropping parameters. Detailed implementation modes can be found in the description of the present embodiment. The same or similar technical features as those in the previous embodiments will not be repeated here.

As illustrated by FIG. 3, the method provided by the present embodiment may include the following steps.

In S310, in response to an effect trigger operation for a target effect, the image to be cropped is acquired, an effect action object in the image to be cropped is determined, the effect action object is taken as the target cropping object, and preset image cropping parameters corresponding to the target effect are acquired as the image cropping parameters corresponding to the image to be cropped. Here, the image cropping parameters include the first area proportion threshold of the target cropping object in the target cropping image.

In the present embodiment, the target effect can be an effect prop that allows for effects to be applied only to specific objects in an image. The target effect can be of any kind and may be an effect prop that stylizes specific objects in the image, such as users, pets, and buildings.

In the present embodiment, in application software or application programs supporting the effect image processing function, a control for triggering effects can be preset, and in response to detecting that the control is triggered by users, the effect trigger operation can be responded to, so that the object to be cropped can be obtained.

In practical application, the image to be cropped can only be obtained when some effect operations are triggered. The effect trigger operations can include at least one of the following: triggering an effect props; triggering effect wake-up words by audio information; and a current body movement being consistent with a preset body movement.

In the present embodiment, a control for triggering an effect prop can be preset, and in response to users triggering the control, an effect prop display page can pop up on a display interface. A plurality of effect props can be displayed in the display page. Users can trigger the corresponding effect prop. Detection of a user-triggered effect prop corresponding to a target effect indicates activation of an effect trigger operation for the target effect. Another implementation mode involves pre-collecting user audio information, and analyzing the collected audio information to identify the text corresponding to the audio information; and if the text corresponding to the audio information includes preset wake-up words such as “Capture current image” or “Activate effect function”, which refers to that an image to be cropped in the display interface can be obtained. In yet another implementation mode, some body movements can be preset as effect trigger movements; in response to detecting that a current body movement of the user within the field of view are consistent with a preset body movement, it is determined that an effect operation is triggered; and alternatively, the preset body movements can be raising hand, opening mouth, or turning head.

In the present embodiment, the effect action object can be an object to which the target effect is applied, and it can also be understood as an object included in the image to be cropped that can be subjected to effect processing. The effect action object can be any object, such as users, pets, buildings and landscapes.

In practical application, the object type of the effect action object can be preset and used as a preset object type. Further, in response to acquiring the image to be cropped, the object type of each object included in the image to be cropped can be detected, each object type can be matched with the preset object type, the object with an object type matching the preset object type can be taken as the effect action object in the image to be cropped, and the determined effect action object can be taken as the target cropping object. Alternatively, any object can be determined as an effect action object in advance and used as a preset action object. Further, in response to acquiring the object to be cropped, each object included in the object to be cropped can be detected and matched with the preset action object. The object matching the preset action object can be taken as the effect action object in the image to be cropped, and the determined effect action object can be taken as the target cropping object. Alternatively, in response to acquiring the object to be cropped, for each object included in the acquired object to be cropped, users can make selections within the image to be cropped through a trigger operation; in response to detecting a selection trigger operation for any object, the object can be taken as the effect action object in the image to be cropped; and the determined effect action object can be taken as the target cropping object.

It should be noted that there may be one or more acquired images to be cropped. In a case where there is one acquired image to be cropped, the image to be cropped may include one or more objects. In a case where the image to be cropped includes one object, the object can be used as the effect action object. In a case where the image to be cropped includes a plurality of objects, the effect action object can be selected from the plurality of objects according to predetermined effect action object determination logic. In a case where there are a plurality of acquired images to be cropped, in response to presetting the object type of the effect action object, or determining any object as the effect action object in advance, it is possible for any one or more of the acquired images to be cropped to not include the effect action object. In this case, these images to be cropped can be directly skipped and not processed.

In the present embodiment, in an effect development stage of the target effect, different image cropping parameters can be set according to the effects of effect action objects of different object types after the target effect is applied, each image cropping parameter is associated with an object type, and the image cropping parameters and identifiers of the object types are stored in a configuration library of application software.

In the practical application process, in response to detecting the effect trigger operation for the target effect and determining the effect action object in the image to be cropped, the object type of the effect action object can be determined, and the matching image cropping parameters can be retrieved from the configuration library according to the object type, so that the retrieved image cropping parameters can be taken as the image cropping parameters corresponding to the image to be cropped.

S320: processing the image to be cropped, determining a bounding box corresponding to the target cropping object in the image to be cropped, and determining box center point information of the bounding box.

S330: determining region center point information based on the box center point information, and determining a preliminary cropping region corresponding to the image to be cropped based on the region center point information and the first area proportion threshold.

S340: determining a target cropping region corresponding to the image to be cropped based on a relative position relationship between the preliminary cropping region and the image to be cropped, and determining the target cropping image corresponding to the image to be cropped based on the target cropping region.

In practical application, after the target cropping image is obtained, the target cropping image can be processed by using an effect processing tool corresponding to the target effect, so as to obtain a target effect image. The target effect image can be an image corresponding to an effect display effect of the target effect. For example, the target effect may be an image stylization effect, and the effect processing tool corresponding to the target effect may be an effect processing tool including a stylization processing model. After obtaining the target cropping image, the target cropping image can be processed according to the stylization processing model to stylize the target cropping object included in the target cropping image. Further, the target effect image can be obtained after texture stylization and/or deformation processing of the target cropping object.

According to the technical solution of the embodiments of the present disclosure, in response to the effect trigger operation for the target effect, the image to be cropped is acquired, the effect action object in the image to be cropped is determined, the effect action object is taken as the target cropping object, and preset image cropping parameters corresponding to the target effect are acquired as the image cropping parameters corresponding to the image to be cropped. Here, the image cropping parameters include the first area proportion threshold of the target cropping object in the target cropping image. Then, the image to be cropped is processed to determine the bounding box corresponding to the target cropping object in the image to be cropped, and the box center point information of the bounding box is determined; further, the region center point information is determined based on the box center point information, and the preliminary cropping region corresponding to the image to be cropped is determined based on the region center point information and the first area proportion threshold; and finally, based on the relative position relationship between the preliminary cropping region and the image to be cropped, the target cropping region corresponding to the image to be cropped is determined, and the target cropping image corresponding to the image to be cropped is determined based on the target cropping region. In this way, the effect of applying the image cropping function to an effect processing scene is realized, the universality of effect processing props is improved, and the effect processing effectiveness is improved.

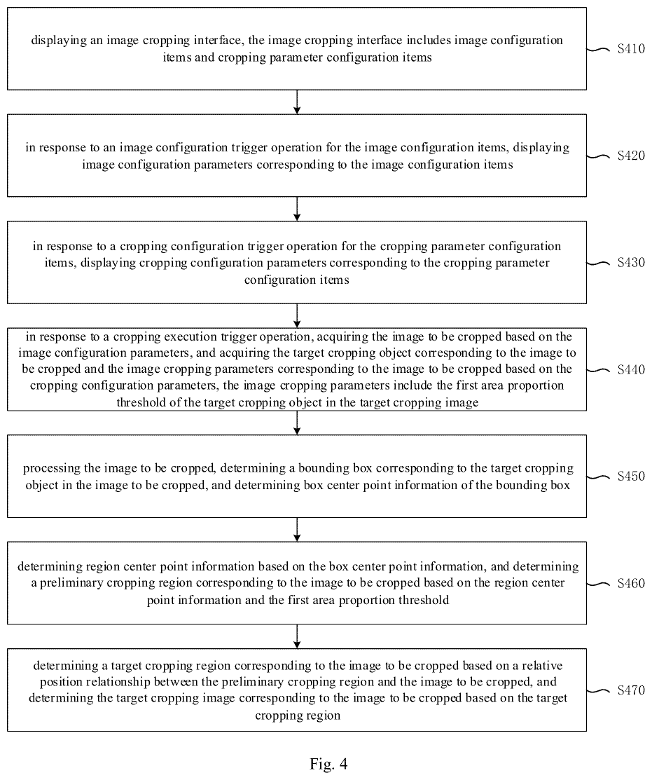

FIG. 4 is a flow diagram of an image cropping method according to an embodiment of the present disclosure. On the basis of the above embodiment, the technical solution of the present embodiment determines image configuration parameters in response to an image configuration trigger operation for image configuration items included in an image cropping interface, and determines cropping configuration parameters in response to a cropping configuration trigger operation for cropping parameter configuration items included in the image cropping interface. Further, in response to a cropping execution trigger operation, the image to be cropped is obtained according to the image configuration parameters, and the target cropping object in the image to be cropped and the image cropping parameters are obtained according to the cropping configuration parameters. Detailed implementation modes can be found in the description of the present embodiment. The same or similar technical features as those in the previous embodiments will not be repeated here.

As illustrated by FIG. 4, the method provided by the present embodiment may include the following steps.

S410: displaying an image cropping interface. Here, the image cropping interface includes image configuration items and cropping parameter configuration items.

In the present embodiment, the image cropping interface may be a visual interface for cropping an image. In practical application, an interface display trigger operation for displaying the image cropping interface can be preset, so that in response to detecting the interface display trigger operation, the interface display trigger operation can be responded to, thereby displaying the image cropping interface on the display interface. Alternatively, the interface display trigger operation may include at least one of the following operations: triggering an interface display control; receiving an interface display trigger instruction; audio information including wake-up words corresponding to the interface display trigger operation; and so on.

In the present embodiment, the image cropping interface includes the image configuration items and the cropping parameter configuration items. Here, the image configuration item can be a control that configures the image that needs to be cropped. Alternatively, the image configuration items may include an image acquisition path, an image acquisition quantity, a selected image, etc. The cropping parameter configuration item can be a control that configures cropping parameters applied in the image cropping process. Alternatively, the cropping parameter configuration items may include a cropping object configuration item, an area proportion threshold configuration item, and a target image aspect ratio configuration item.

In practical application, upon detecting the interface display trigger operation, the image cropping interface can be displayed on the display interface of a terminal device in response to the trigger operation. In addition, the image configuration items and the cropping parameter configuration items can be displayed in the image cropping interface, so that users can configure the image to be cropped and the image cropping parameters by inputting trigger operations for the image configuration items and the cropping parameter configuration items.

S420: in response to an image configuration trigger operation for the image configuration items, displaying image configuration parameters corresponding to the image configuration items.

In the present embodiment, the image configuration trigger operation for the image configuration items can be any operation acting on the image configuration items. Alternatively, it can be a click operation for the image configuration items. Here, the click operation can be either a single-click operation or a multiple-click operation (e.g., double-click operation). In the present embodiment, the image configuration parameters can be parameters for determining the image to be cropped.

In practical application, the image configuration items are updated to a configurable state in response to the image configuration trigger operation for the image configuration items. Then, image parameters of the image configuration items are configured based on an input device. In response to detecting that the interface remains inactive for preset duration, or detecting a trigger operation for any position of the image cropping interface, it can be determined that the parameter configuration process of the image configuration items is completed. Therefore, the configured image parameters can be used as the image configuration parameters corresponding to the image configuration items and displayed.

S430: in response to a cropping configuration trigger operation for the cropping parameter configuration items, displaying cropping configuration parameters corresponding to the cropping parameter configuration items.

The cropping configuration parameters include at least one of cropping object configuration parameters, a first area proportion threshold of the target cropping object in the target cropping image, and a target image aspect ratio corresponding to the target cropping image obtained by cropping the image to be cropped.

Here, the cropping object configuration parameters may be parameters for configuring the target cropping object in the image to be cropped. Alternatively, the cropping object configuration parameters may include at least one of an object attribute, an object type and a specific target object.

In the present embodiment, the cropping configuration trigger operation for the cropping parameter configuration items can be any operation acting on the cropping parameter configuration items. Alternatively, it can be a click operation for the cropping parameter configuration items. Here, the click operation can be either a single-click operation or a multiple-click operation (e.g., double-click operation). The cropping configuration parameters may be configuration parameters for the target cropping object and the image cropping parameters.

In practical application, the cropping parameter configuration items are updated to a configurable state in response to the cropping configuration trigger operation for the cropping parameter configuration items. Then, the cropping parameters of the cropping parameter configuration items are configured based on the input device. In response to detecting that the interface remains inactive for preset duration, or detecting a trigger operation for any position of the image cropping interface, it can be determined that the parameter configuration process of the cropping parameter configuration items is completed. Therefore, the configured cropping parameters can be used as the cropping configuration parameters and displayed.

S440: in response to a cropping execution trigger operation, acquiring the image to be cropped based on the image configuration parameters, and acquiring the target cropping object corresponding to the image to be cropped and the image cropping parameters corresponding to the image to be cropped based on the cropping configuration parameters. Here, the image cropping parameters include the first area proportion threshold of the target cropping object in the target cropping image.

In the present embodiment, a control for triggering cropping execution can be preset in the image cropping interface, or a segment of program code for triggering cropping execution can be preset. In the application process, in response to detecting that users trigger the control, or receiving the program code, it can be determined that the cropping execution trigger operation is detected, and then the trigger operation is responded to.

In practical application, in response to detecting the cropping execution trigger operation, the trigger operation is responded to. According to the image configuration parameters displayed in the image cropping interface, the image to be cropped is determined and acquired; and according to the cropping configuration parameters displayed in the image cropping interface, the target cropping object in the image to be cropped and the image cropping parameters corresponding to the image to be cropped are determined. Therefore, the image to be cropped can be cropped according to the obtained target cropping object and image cropping parameters, and then the target cropping image can be obtained.

S450: processing the image to be cropped, determining a bounding box corresponding to the target cropping object in the image to be cropped, and determining box center point information of the bounding box.

S460: determining region center point information based on the box center point information, and determining a preliminary cropping region corresponding to the image to be cropped based on the region center point information and the first area proportion threshold.

S470: determining a target cropping region corresponding to the image to be cropped based on a relative position relationship between the preliminary cropping region and the image to be cropped, and determining the target cropping image corresponding to the image to be cropped based on the target cropping region.

According to the technical solution of the embodiments of the present disclosure, the image cropping interface is displayed, which includes the image configuration items and the cropping parameter configuration items. Then, the image configuration parameters corresponding to the image configuration items are displayed in response to the image configuration trigger operation for the image configuration items, and the cropping configuration parameters corresponding to the cropping parameter configuration items are displayed in response to the cropping configuration trigger operation for the cropping parameter configuration items. Then, in response to the cropping execution trigger operation, the image to be cropped is acquired based on the image configuration parameters, and the target cropping object corresponding to the image to be cropped and the image cropping parameters corresponding to the image to be cropped are acquired based on the cropping configuration parameters. Further, the image to be cropped is processed to determine the bounding box corresponding to the target cropping object in the image to be cropped, and the box center point information of the bounding box is determined; then, the region center point information is determined based on the box center point information, and the preliminary cropping region corresponding to the image to be cropped is determined based on the region center point information and the first area proportion threshold; and finally, based on the relative position relationship between the preliminary cropping region and the image to be cropped, the target cropping region corresponding to the image to be cropped is determined, and the target cropping image corresponding to the image to be cropped is determined based on the target cropping region. This approach achieves the visualization of the image cropping process, which can be easily implemented through simple interactive operations, thus broadening its applicability and enhancing the user experience of the image cropping function.

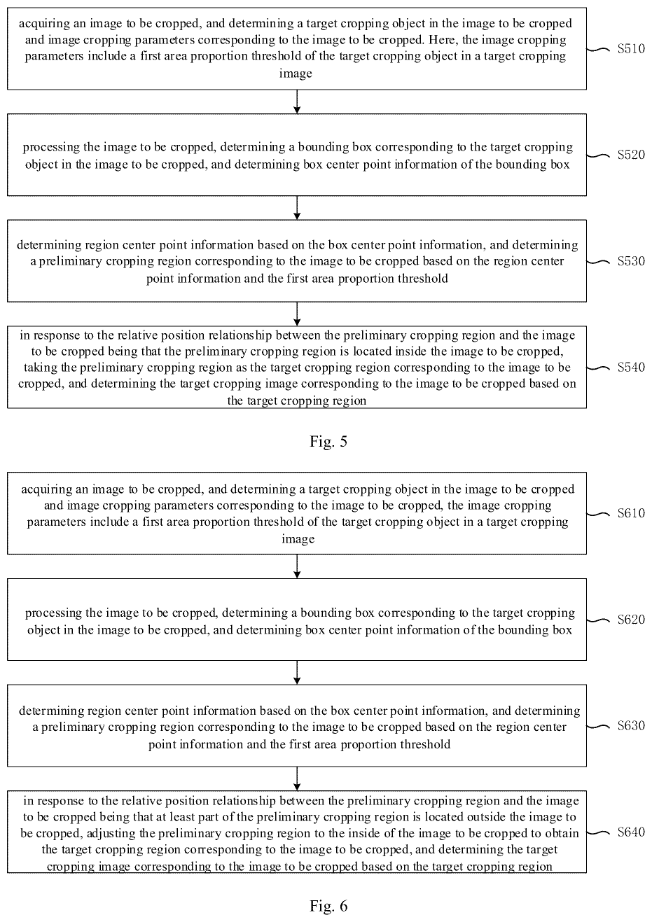

FIG. 5 is a flow diagram of an image cropping method according to an embodiment of the present disclosure. On the basis of the above embodiment, the technical solution of the present embodiment determines the position relationship between the determined preliminary cropping region and the image to be cropped, takes the preliminary cropping region as the target cropping region in response to the preliminary cropping region being located inside the image to be cropped, and determines the target cropping image according to the determined target cropping region. Detailed implementation modes can be found in the description of the present embodiment. The same or similar technical features as those in the previous embodiments will not be repeated here.

As illustrated by FIG. 5, the method provided by the present embodiment may include the following steps.

S510: acquiring an image to be cropped, and determining a target cropping object in the image to be cropped and image cropping parameters corresponding to the image to be cropped. Here, the image cropping parameters include a first area proportion threshold of the target cropping object in a target cropping image.

S520: processing the image to be cropped, determining a bounding box corresponding to the target cropping object in the image to be cropped, and determining box center point information of the bounding box.

S530, determining region center point information based on the box center point information, and determining a preliminary cropping region corresponding to the image to be cropped based on the region center point information and the first area proportion threshold.

S540, in response to the relative position relationship between the preliminary cropping region and the image to be cropped being that the preliminary cropping region is located inside the image to be cropped, taking the preliminary cropping region as the target cropping region corresponding to the image to be cropped, and determining the target cropping image corresponding to the image to be cropped based on the target cropping region.

In the present embodiment, the preliminary cropping region being located inside the image to be cropped can be understood as each pixel in the preliminary cropping region being able to be sampled based on the coordinate information of the image to be cropped, and pixel values corresponding to each pixel being able to be obtained; and it can also be understood as the coordinate information of the image to be cropped including the coordinate information corresponding to the preliminary cropping region.

In practical application, after determining the preliminary cropping region corresponding to the object to be cropped, the coordinate information of the preliminary cropping region can be compared with the coordinate information of the image to be cropped to determine the relative position relationship between the preliminary cropping region and the image to be cropped. Further, in response to determining that the relative position relationship between the preliminary cropping region and the image to be cropped is that the preliminary cropping region is located inside the image to be cropped, it is determined that the determined preliminary cropping region is completely located inside the image to be cropped on the premise of meeting the first area proportion threshold and the target image aspect ratio, that is, meeting the image cropping requirements. Further, the preliminary cropping region can be taken as the target cropping region corresponding to the image to be cropped, and the target cropping image corresponding to the image to be cropped can be determined according to the target cropping region.

According to the technical solution of the embodiments of the present disclosure, the image to be cropped is acquired, and the target cropping object in the image to be cropped and the image cropping parameters corresponding to the image to be cropped are determined. Here, the image cropping parameters include the first area proportion threshold of the target cropping object in the target cropping image. Then, the image to be cropped is processed to determine the bounding box corresponding to the target cropping object in the image to be cropped, and the box center point information of the bounding box is determined. Further, the region center point information is determined based on the box center point information, and the preliminary cropping region corresponding to the image to be cropped is determined based on the region center point information and the first area proportion threshold. Finally, in response to the relative position relationship between the preliminary cropping region and the image to be cropped being that the preliminary cropping region is located inside the image to be cropped, the preliminary cropping region is taken as the target cropping region corresponding to the image to be cropped, and the target cropping image corresponding to the image to be cropped is determined based on the target cropping region. The effect of determining the target cropping region and the target cropping image under the condition that the preliminary cropping region is located in the image to be cropped is realized.

FIG. 6 is a flow diagram of an image cropping method according to an embodiment of the present disclosure. On the basis of the above embodiment, the technical solution of the present embodiment determines the position relationship between the determined preliminary cropping region and the image to be cropped; in response to determining that at least part of the preliminary cropping region is located outside the image to be cropped, adjusts the preliminary cropping region, so as to determine the target cropping region based on the adjusted preliminary cropping region; and determines the target cropping image according to the determined target cropping region. Detailed implementation modes can be found in the description of the present embodiment. The same or similar technical features as those in the previous embodiments will not be repeated here.

As illustrated by FIG. 6, the method provided by the present embodiment may include the following steps.

S610: acquiring an image to be cropped, and determining a target cropping object in the image to be cropped and image cropping parameters corresponding to the image to be cropped. Here, the image cropping parameters include a first area proportion threshold of the target cropping object in a target cropping image.

S620: processing the image to be cropped, determining a bounding box corresponding to the target cropping object in the image to be cropped, and determining box center point information of the bounding box.

S630: determining region center point information based on the box center point information, and determining a preliminary cropping region corresponding to the image to be cropped based on the region center point information and the first area proportion threshold.

S640, in response to the relative position relationship between the preliminary cropping region and the image to be cropped being that at least part of the preliminary cropping region is located outside the image to be cropped, adjusting the preliminary cropping region to the inside of the image to be cropped to obtain the target cropping region corresponding to the image to be cropped, and determining the target cropping image corresponding to the image to be cropped based on the target cropping region.

In the present embodiment, at least part of the preliminary cropping region being located outside the image to be cropped can be understood as the pixels in at least part of the preliminary cropping region being unable to be sampled based on the coordinate information of the image to be cropped, that is, pixel values corresponding to the pixels in at least part of the preliminary cropping region are preset pixel values. Here, the preset pixel value can be any value, such as a null value. Alternatively, it can also be understood as the coordinate information of the image to be cropped including the coordinate information of at least part of the preliminary cropping region.

In practical application, in a case where it is determined that the relative position relationship between the preliminary cropping region and the image to be cropped is that at least part of the preliminary cropping region is located outside the image to be cropped, if the preliminary cropping region is directly taken as the target cropping region and the target cropping image is determined based on the target cropping region, the pixel values of at least some pixels in the obtained target cropping image are null, which does not meet the image cropping requirements. Therefore, the preliminary cropping region can be adjusted to the inside of the image to be cropped, so as to determine the target cropping region according to the adjusted preliminary cropping region. Specifically, at least part of the preliminary cropping region that is located outside the image to be cropped can be determined, and part of the image region that does not include the preliminary cropping region in the image to be cropped is determined. Further, the preliminary cropping region can be adjusted according to the determined at least part of the preliminary cropping region and part of the image region, so that the adjusted preliminary cropping region is completely located inside the image to be cropped.

Alternatively, the step of adjusting the preliminary cropping region to the inside of the image to be cropped to obtain the target cropping region corresponding to the image to be cropped includes: determining region boundaries of the preliminary cropping region and image boundaries of the image to be cropped; traversing each of the region boundaries, taking a region boundary outside the image boundaries as a boundary to be processed, and taking a region boundary opposite the boundary to be processed as a reference boundary; and based on a relative position relationship between the boundary to be processed, an image boundary on the same side as the boundary to be processed, the reference boundary and an image boundary on the same side as the reference boundary, adjusting the preliminary cropping region to obtain the target cropping region corresponding to the image to be cropped.

In the present embodiment, the region boundaries can be boundaries that distinguish between the interior and exterior of the preliminary cropping region, that is, one side of the region boundaries falls within the preliminary cropping region, constituting a part of it, while the other side is outside the preliminary cropping region, not being part of it. For example, if the preliminary cropping region is a rectangular region, the region boundaries may include a left region boundary, a right region boundary, an upper region boundary and a lower region boundary. Similarly, the image boundaries can be boundaries that distinguish between the interior and exterior of the image to be cropped, that is, one side of the image boundaries falls within the image to be cropped, constituting a part of it, while the other side is outside the image to be cropped, not being part of it. For example, if the image to be cropped is a rectangular image, the image boundaries may include a left image boundary, a right image boundary, an upper image boundary and a lower image boundary.

In practical application, the region boundaries can be determined according to the coordinate information of the preliminary cropping region, and the image boundaries can be determined according to the coordinate information of the image to be cropped. Further, each determined region boundary is traversed to determine the region boundaries outside the image boundaries. The region boundaries outside the image boundaries can be taken as the boundaries to be processed. It should be noted that the image boundary exceeded by the boundary to be processed is on the same side as the boundary to be processed. Meanwhile, the region boundary opposite the boundary to be processed is taken as the reference boundary. For example, if the region boundary outside the image boundary is the left region boundary, then the left region boundary of the preliminary cropping region can be taken as the boundary to be processed, the image boundary exceeded by the boundary to be processed can be the left image boundary of the image to be cropped, and the region boundary opposite the boundary to be processed is the right region boundary, which can be taken as the reference boundary.

In the present embodiment, after determining the boundary to be processed and the reference boundary, the relative position relationship between the boundary to be processed, the image boundary on the same side as the boundary to be processed, the reference boundary and the image boundary on the same side as the reference boundary can be determined, and further, the preliminary cropping region can be adjusted according to the determined relative position relationship. The relative position relationship can include the relative position information between the boundary to be processed and the image boundary on the same side as the boundary to be processed, and the relative position information between the reference boundary and the image boundary on the same side as the reference boundary.

In practical application, after determining the boundary to be processed and the reference boundary, in order to adjust the whole preliminary cropping region to the inside of the image to be cropped, the boundary to be processed can be compared with the image boundary on the same side as the boundary to be processed, and the relative position information between the boundary to be processed and the image boundary can be determined. Meanwhile, the reference boundary can be compared with the image boundary on the same side as the reference boundary, and the relative position information between the reference boundary and the image boundary is determined. Further, according to the determined two pieces of relative position information, the preliminary cropping region can be adjusted to obtain the target cropping region corresponding to the image to be cropped.

Alternatively, the step of, based on a relative position relationship between the boundary to be processed, an image boundary on the same side as the boundary to be processed, the reference boundary and an image boundary on the same side as the reference boundary, adjusting the preliminary cropping region to obtain the target cropping region corresponding to the image to be cropped, includes: based on first relative position information between the boundary to be processed and the image boundary on the same side as the boundary to be processed, determining a target moving distance of the preliminary cropping region from a side corresponding to the boundary to be processed to the reference boundary; according to second relative position information between the reference boundary and the image boundary on the same side as the reference boundary, determining a maximum moving distance of the preliminary cropping region; and based on a minimum moving distance between the target moving distance and the maximum moving distance, moving the preliminary cropping region towards the reference boundary, and determining the target cropping region corresponding to the image to be cropped based on the preliminary cropping region as moved.

In the present embodiment, the first relative position information may be information representing the relative position relationship between the boundary to be processed and the image boundary on the same side as the boundary to be processed. The first relative position information can be used to characterize the specific extent by which the boundary to be processed exceeds the image boundary on the same side as the boundary to be processed. In practical application, after determining the boundary to be processed and the image boundary on the same side as the boundary to be processed, the coordinate information of the boundary to be processed can be determined according to the coordinate information of the preliminary cropping region, and the coordinate information of the image boundary on the same side as the boundary to be processed can be determined according to the coordinate information of the image to be cropped. Further, the first relative position information between the boundary to be processed and the image boundary on the same side as the boundary to be processed can be determined according to the coordinate information of the boundary to be processed and the coordinate information of the image boundary on the same side as the boundary to be processed.

In the present embodiment, the target moving distance can be the distance that the preliminary cropping region needs to move to the inside of the image to be cropped, and the moving direction can be from the side of the boundary to be processed to the side of the reference boundary.

In practical application, after determining the first relative position information, the distance between the boundary to be processed and the image boundary on the same side as the boundary to be processed can be determined. In order to adjust the preliminary cropping region to the inside of the image to be cropped, the preliminary cropping region can be adjusted so that the boundary to be processed at least coincides with the image boundary on the same side as the boundary to be processed. Therefore, the relative distance between the boundary to be processed and the image boundary on the same side as the boundary to be processed can be taken as the target moving distance for the preliminary cropping region to move from the side of the boundary to be processed to the side of the reference boundary. For example, assuming that the distance between the boundary to be processed and the image boundary on the same side as the boundary to be processed is l₁, that is, the distance that the boundary to be processed exceeds the image boundary is l₁, in order to adjust the boundary to be processed to the inside of the image to be cropped, the target moving distance for the preliminary cropping region to move from the side of the boundary to be processed to the side of the reference boundary can be l₁.

In the present embodiment, the second relative position information may be information representing the relative position relationship between the reference boundary and the image boundary on the same side as the reference boundary. In practical application, after determining the reference boundary and the image boundary on the same side as the reference boundary, the coordinate information of the reference boundary can be determined according to the coordinate information of the preliminary cropping region, and the coordinate information of the image boundary on the same side as the reference boundary can be determined according to the coordinate information of the image to be cropped. Further, the second relative position information between the reference boundary and the image boundary on the same side as the reference boundary can be determined according to the coordinate information of the reference boundary and the coordinate information of the image boundary on the same side as the reference boundary. The maximum moving distance can be a maximum distance that the preliminary cropping region moves within the image to be cropped on the premise that the reference boundary does not exceed the image boundary on the same side. The maximum moving distance can be used to characterize the distance between the reference boundary and the image boundary on the same side as the reference boundary.

In practical application, after determining the second relative position information, the distance between the reference boundary and the image boundary on the same side as the reference boundary can be determined according to the second relative position information. Further, the determined distance can be taken as the maximum moving distance of the preliminary cropping region. For example, assuming that the distance between the reference boundary and the image boundary on the same side as the reference boundary is 12, the maximum moving distance of the preliminary cropping region is 12.

In the present embodiment, after the target moving distance and the maximum moving distance are determined, the preliminary cropping region can be adjusted based on a minimum moving distance between the target moving distance and the maximum moving distance.

The minimum moving distance can be the minimum value between the target moving distance and the maximum moving distance.

In practical application, in order to ensure that the preliminary cropping region is completely located inside the image to be cropped after moving from the side of the boundary to be processed to the side of the reference boundary, after the target moving distance and the maximum moving distance are determined, the minimum value of the target moving distance and the maximum moving distance can be obtained, which can be taken as the minimum moving distance. Further, according to the minimum moving distance, the preliminary cropping region can be moved to the side of the reference boundary. Therefore, the target cropping region corresponding to the object to be cropped can be determined according to the preliminary cropping region as moved.

In practical application, after the target moving distance and the maximum moving distance are determined, there may be cases where the target moving distance is less than or equal to the maximum moving distance, or the target moving distance is greater than the maximum moving distance.

In a case where the target moving distance is less than the maximum moving distance, the minimum moving distance between the target moving distance and the maximum moving distance can be the target moving distance. After moving the preliminary cropping region to the side of the reference boundary based on the minimum moving distance, the reference boundary does not exceed the image boundary on the same side because the maximum moving distance is greater than the target moving distance, so the preliminary cropping region as moved can be taken as the target cropping region.

In a case where the target moving distance is equal to the maximum moving distance, the minimum moving distance between the target moving distance and the maximum moving distance can be the target moving distance or the maximum moving distance. After the preliminary cropping region is moved to the side of the reference boundary based on the minimum moving distance, the reference boundary just coincides with the image boundary on the same side because the maximum moving distance is equal to the target moving distance, indicating that the preliminary cropping region is located in the image to be cropped, so the preliminary cropping region as moved can be taken as the target cropping region.

In a case where the target moving distance is greater than the maximum moving distance, the minimum moving distance between the target moving distance and the maximum moving distance may be the maximum moving distance. After the preliminary cropping region is moved to the side of the reference boundary based on the minimum moving distance, the boundary to be processed still exceeds the image boundary on the same side by a certain distance because the maximum moving distance is less than the target moving distance, that is, at least part of the preliminary cropping region is still outside the image to be cropped. In this case, in order to ensure that the first area proportion threshold of the target cropping object in the target cropping image and the target image aspect ratio corresponding to the target cropping image do not change, the preliminary cropping region as moved can be scaled. Therefore, the target cropping region can be determined according to the scaled preliminary cropping region.

Alternatively, the step of determining the target cropping region corresponding to the image to be cropped based on the preliminary cropping region as moved includes: in response to the target moving distance being greater than the maximum moving distance, based on third relative position information between the boundary to be processed after moving and the image boundary on the same side with the boundary to be processed, determining a target scaling ratio corresponding to a region boundary adjacent to the boundary to be processed; scaling the preliminary cropping region as moved based on the target scaling ratio, so that the boundary to be processed is located inside the image to be cropped; and determining the target cropping region corresponding to the image to be cropped based on the boundary to be processed after scaling.

In the present embodiment, the third relative position information may be information representing the relative position relationship between the boundary to be processed after moving and the image boundary on the same side as the boundary to be processed. In practical application, the coordinate information of the boundary to be processed after moving can be determined according to the coordinate information of the boundary to be processed before moving and the minimum moving distance. Further, the third relative position information between the boundary to be processed after moving and the image boundary on the same side as the boundary to be processed can be determined according to the coordinate information of the boundary to be processed after moving and the determined coordinate information of the image boundary on the same side as the boundary to be processed. The target scaling ratio can be the proportion by which the region boundary adjacent to the boundary to be processed needs to be adjusted when the boundary to be processed is adjusted to the inside of the image to be cropped.

In practical application, after determining the third relative position information, the distance between the boundary to be processed after moving and the image boundary on the same side as the boundary to be processed can be determined. In order to reduce the distance to 0 without moving the preliminary cropping region, the target scaling ratio corresponding to the region boundary adjacent to the boundary to be processed can be determined according to the distance. Specifically, a target scaling distance corresponding to the region boundary can be determined according to a boundary length value of the region boundary adjacent to the boundary to be processed and the determined distance between the boundary to be processed and the image boundary on the same side as the boundary to be processed. For example, if the boundary to be processed is the left region boundary, the image boundary on the same side as the left region boundary is the left image boundary, and the region boundaries adjacent to the boundary to be processed are the upper region boundary and the lower region boundary. The distance between the moved left region boundary and the left image boundary is a first distance, and a boundary length value of the upper region boundary or the lower region boundary can be a width value of the preliminary cropping region. Further, half of the width value can be determined to obtain a width value to be processed. Then, a difference between the width value to be processed and the first distance is determined, and a ratio between the difference and the width value to be processed is determined, which can be used as the target scaling ratio corresponding to the upper region boundary and the lower region boundary.

Further, after obtaining the target scaling ratio, the target scaling ratio corresponding to the boundary to be processed and the reference boundary can be determined according to the target scaling ratio and the target image aspect ratio. Further, the preliminary cropping region as moved can be scaled according to the target scaling ratio and the target image aspect ratio, so that the boundary to be processed after scaling is located inside the image to be cropped. Moreover, the coordinate information of the region boundary can be updated according to the scaled preliminary cropping region. After that, region boundaries of the scaled preliminary cropping region are determined, and each region boundary is traversed to determine whether there are region boundaries outside the image boundaries. If there are region boundaries outside the image boundaries, for the region boundaries outside the image boundaries, the preliminary cropping region moving step and/or the preliminary cropping region as moved scaling step can be performed again until each region boundary in the obtained preliminary cropping region is located inside the image to be cropped. Therefore, the target cropping region corresponding to the image to be cropped can be determined based on the boundary to be processed after scaling. The advantage of this approach is that the preliminary cropping region is processed under the condition that the moved region boundary is still located outside the image to be cropped, so that the processed region boundary is located inside the image to be cropped, and the image cropping effect is guaranteed on the premise of meeting the image cropping requirements.

According to the technical solution of the embodiments of the present disclosure, the image to be cropped is acquired, and the target cropping object in the image to be cropped and the image cropping parameters corresponding to the image to be cropped are determined. Here, the image cropping parameters include the first area proportion threshold of the target cropping object in the target cropping image. Then, the image to be cropped is processed to determine the bounding box corresponding to the target cropping object in the image to be cropped, and the box center point information of the bounding box is determined. Further, the region center point information is determined based on the box center point information, and the preliminary cropping region corresponding to the image to be cropped is determined based on the region center point information and the first area proportion threshold. Finally, in response to the relative position relationship between the preliminary cropping region and the image to be cropped being that at least part of the preliminary cropping region is located outside the image to be cropped, the preliminary cropping region is adjusted to the inside of the image to be cropped to obtain the target cropping region corresponding to the image to be cropped, and the target cropping image corresponding to the image to be cropped is determined based on the target cropping region. In this way, the preliminary cropping region is adjusted under the condition that part of the preliminary cropping region is located outside the image to the cropped, so that the adjusted preliminary cropping region is located inside the image to be cropped, which improves the intelligence of the image cropping function and enhances the display effect of the target cropping image.

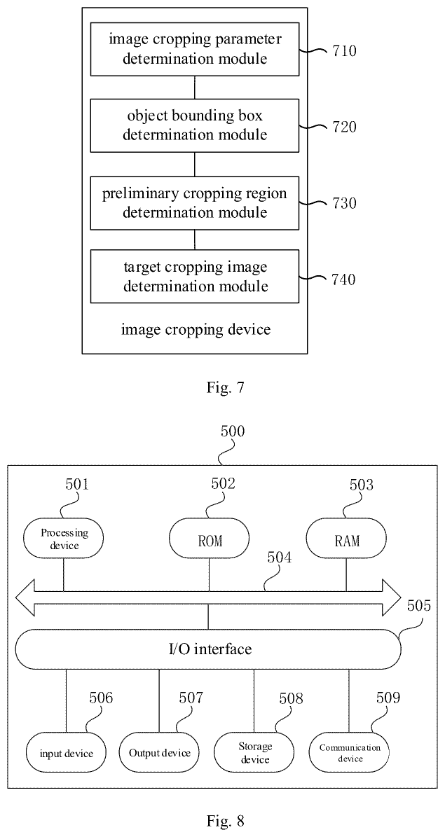

FIG. 7 is a structural diagram of an image cropping device according to an embodiment of the present disclosure. As illustrated by FIG. 7, the apparatus includes an image cropping parameter determination module 710, an object bounding box determination module 720, a preliminary cropping region determination module 730 and a target cropping image determination module 740.

The image cropping parameter determination module 710 is configured to acquire an image to be cropped, and determine a target cropping object in the image to be cropped and image cropping parameters corresponding to the image to be cropped, the image cropping parameters including a first area proportion threshold of the target cropping object in a target cropping image; the object bounding box determination module 720 is configured to process the image to be cropped, determine a bounding box corresponding to the target cropping object in the image to be cropped, and determine box center point information of the bounding box; the preliminary cropping region determination module 730 is configured to determine region center point information based on the box center point information, and determine a preliminary cropping region corresponding to the image to be cropped based on the region center point information and the first area proportion threshold; and the target cropping image determination module 740 is configured to determine a target cropping region corresponding to the image to be cropped based on a relative position relationship between the preliminary cropping region and the image to be cropped, and determine the target cropping image corresponding to the image to be cropped based on the target cropping region.

Alternatively, the image cropping parameters include a target image aspect ratio corresponding to the target cropping image obtained by cropping the image to be cropped; and accordingly, the preliminary cropping region determination module 730 is further configured to determine region center point information based on the box center point information, and determine a preliminary cropping region corresponding to the image to be cropped based on the region center point information, the first area proportion threshold and the target image aspect ratio.

Alternatively, the preliminary cropping region determination module 730 includes an original area proportion determination unit and a preliminary cropping region determination unit. The original area proportion determination unit is configured to determine an original area proportion of the target cropping object in the target cropping image based on a bounding area of the bounding box and an image area of the image to be cropped; and the preliminary cropping region determination unit is configured to, in response to the original area proportion being less than the area proportion threshold, determine the preliminary cropping region corresponding to the image to be cropped based on the region center point information and the first area proportion threshold.

Alternatively, the image cropping parameters include a target image aspect ratio corresponding to the target cropping image obtained by cropping the image to be cropped; and accordingly, the apparatus further includes a target cropping region determination module. The target cropping region determination module is configured to, after determining an original area proportion of the target cropping object in the target cropping image based on a bounding area of the bounding box and an image area of the image to be cropped, in response to the original area proportion being greater than or equal to the area proportion threshold, determine a target cropping region corresponding to the image to be cropped based on an original image aspect ratio of the image to be cropped and the target image aspect ratio, and determine a target cropping image corresponding to the image to be cropped based on the target cropping region.

Alternatively, the image cropping parameter determination module 710 includes an image cropping parameter first determination unit. An effect action object determination unit is configured to, in response to an effect trigger operation for a target effect, acquire the image to be cropped, determine an effect action object in the image to be cropped, take the effect action object as the target cropping object, and acquire preset image cropping parameters corresponding to the target effect as the image cropping parameters corresponding to the image to be cropped.

Alternatively, the image cropping parameter determination module 710 includes a cropping interface display unit, an image configuration parameter display unit, a cropping configuration parameter display unit and an image cropping parameter second determination unit. The cropping interface display unit is configured to display an image cropping interface, the image cropping interface including image configuration items and cropping parameter configuration items; the image configuration parameter display unit is configured to in response to an image configuration trigger operation for the image configuration items, display image configuration parameters corresponding to the image configuration items; the cropping configuration parameter display unit is configured to, in response to a cropping configuration trigger operation for the cropping parameter configuration items, display cropping configuration parameters corresponding to the cropping parameter configuration items, the cropping configuration parameters including cropping object configuration parameters and/or image size configuration parameters; and the image cropping parameter second determination unit is configured to, in response to a cropping execution trigger operation, acquire the image to be cropped based on the image configuration parameters, and acquire the target cropping object corresponding to the image to be cropped and the image cropping parameters corresponding to the image to be cropped based on the cropping configuration parameters.

Alternatively, the target cropping image determination module 740 includes a target cropping region first determination submodule and/or a target cropping region second determination submodule. The target cropping region first determination submodule is configured to, in response to the relative position relationship between the preliminary cropping region and the image to be cropped being that the preliminary cropping region is located inside the image to be cropped, take the preliminary cropping region as the target cropping region corresponding to the image to be cropped; and/or, the target cropping region second determination submodule is configured to, in response to the relative position relationship between the preliminary cropping region and the image to be cropped being that at least part of the preliminary cropping region is located outside the image to be cropped, move the preliminary cropping region to the inside of the image to be cropped to obtain the target cropping region corresponding to the image to be cropped.

Alternatively, the target cropping region second determination submodule includes a boundary determination unit, a region boundary traversal unit and a target cropping region determination unit. The boundary determination unit is configured to determine region boundaries of the preliminary cropping region and image boundaries of the image to be cropped; the region boundary traversal unit is configured to traverse each of the region boundaries, take a region boundary outside the corresponding image boundary as a boundary to be processed, and take a region boundary opposite the boundary to be processed as a reference boundary; and the target cropping region determination unit is configured to, based on a relative position relationship between the boundary to be processed, an image boundary on the same side as the boundary to be processed, the reference boundary and an image boundary on the same side as the reference boundary, process the preliminary cropping region to obtain the target cropping region corresponding to the image to be cropped.

Alternatively, the target cropping region determination unit includes a target moving distance determination subunit, a maximum moving distance determination subunit and a target cropping region determination subunit. The target moving distance determination subunit is configured to, based on first relative position information between the boundary to be processed and the image boundary on the same side as the boundary to be processed, determine a target moving distance of the preliminary cropping region from a side corresponding to the boundary to be processed to the reference boundary; the maximum moving distance determination subunit is configured to, according to second relative position information between the reference boundary and the image boundary on the same side as the reference boundary, determine a maximum moving distance of the preliminary cropping region; and the target cropping region determination subunit is configured to, based on a minimum moving distance between the target moving distance and the maximum moving distance, move the preliminary cropping region towards the reference boundary, and determine the target cropping region corresponding to the image to be cropped based on the preliminary cropping region as moved.

Alternatively, the target cropping region determination subunit is specifically configured to, in response to the target moving distance being greater than the maximum moving distance, based on third relative position information between the boundary to be processed after moving and the image boundary on the same side with the boundary to be processed, determine a target scaling ratio corresponding to the preliminary cropping region; scale the preliminary cropping region as moved based on the target scaling ratio, so that the boundary to be processed is located inside the image to be cropped; and determine the target cropping region corresponding to the image to be cropped based on the boundary to be processed after scaling.

Alternatively, the image cropping parameter determination module 710 includes a first area proportion threshold acquisition unit. The first area proportion threshold acquisition unit is configured to acquire a first area proportion threshold corresponding to the target cropping object based on target object parameters associated with the target cropping object, the target object parameters including at least one of the number of the target cropping objects in the image to be cropped, an average value of area proportions of each of the plurality of target cropping objects in the image to be cropped, and distances between the plurality of target cropping objects.

Alternatively, the object bounding box determination module 720 includes a first region center point information determination unit and a second region center point information determination unit.

The first region center point information determination unit is configured to, in response to the box center point information matching coordinate information of the image to be cropped, take the box center point information as the region center point information; and

the second region center point information determination unit is configured to, in response to the box center point information of the bounding box not matching the coordinate information of the image to be cropped, transform coordinate information of the box center point information based on the coordinate information of the image to be cropped, and take the coordinate information after transforming of the box center point information as the region center point information.

Alternatively, the target cropping image determination module 740 is specifically configured to, for each pixel in the target cropping region, perform sampling based on coordinate information of the pixel in the image to be cropped, and perform image rendering based on sampled pixel values, so as to obtain the target cropping image corresponding to the image to be cropped.

According to the technical solution of the embodiments of the present disclosure, the image to be cropped is acquired, and the target cropping object in the image to be cropped and the image cropping parameters corresponding to the image to be cropped are determined, with the image cropping parameters including the first area proportion threshold of the target cropping object in the target cropping image, so that the cropping criteria referred to when the image to be cropped is cropped are accurately determined, laying a foundation for the subsequent cropping process. Then, the image to be cropped is processed, the bounding box corresponding to the target cropping object in the image to be cropped is determined, and the box center point information of the bounding box is determined, so as to accurately determine the position information and area proportion information of the target cropping object in the image to be cropped. Further, the region center point information is determined based on the box center point information, and the preliminary cropping region corresponding to the image to be cropped is determined based on the region center point information and the first area proportion threshold, achieving the effect of preliminarily determining an ideal cropping region centered on the target detection object while meeting the image cropping parameters. Finally, the target cropping region corresponding to the image to be cropped is determined based on the relative position relationship between the preliminary cropping region and the image to be cropped, and the target cropping image corresponding to the image to be cropped is determined based on the target cropping region. This addresses the technical issues, existing in the related art, of laborious and inefficient image cropping, low cropping efficiency, and inconsistent display effects of cropped images, enables cropping of images from any source, and enhances the universality of image cropping functionality. Additionally, it ensures the image cropping effect while meeting the cropping requirements.

The image cropping device provided by the embodiments of the present disclosure can perform the image cropping method provided by any embodiment of the present disclosure, and has corresponding functional modules for executing the method and relevant effects.

It should be noted that the plurality of units and modules included in the apparatus are categorized based on functional logic, but this classification is not restrictive, as long as corresponding functions can be realized. In addition, the names of multiple functional units are only for the convenience of distinguishing each other, and are not used to limit the protection scope of the embodiments of the present disclosure.

FIG. 8 is a structural diagram of an electronic apparatus according to an embodiment of the present disclosure. Referring to FIG. 8, it is a structural diagram of an electronic apparatus (for example, the terminal device or server in FIG. 8) 500 suitable for implementing the embodiments of the present disclosure. The terminal device in the embodiments of the present disclosure may include but not limited to mobile terminals such as mobile phones, notebook computers, digital broadcast receivers, personal digital assistants (PDA), portable android devices (PAD), portable multimedia players (PMP), and vehicle-mounted terminals (such as vehicle-mounted navigation terminals), and fixed terminals such as digital TV and desktop computers. The electronic apparatus shown in FIG. 8 is only an example, and should not impose any limitations on the functionality and scope of use of the embodiments of the present disclosure.

As illustrated by FIG. 8, the electronic apparatus 500 may include a processing device (such as a central processing unit, and a graphics processor) 501, it may execute various appropriate actions and processes according to a program stored in a read-only memory (ROM) 502 or a program loaded from a storage device 508 to a random access memory (RAM) 503. In RAM 503, various programs and data required for operations of the electronic apparatus 500 are also stored. The processing device 501, ROM 502, and RAM 403 are connected to each other by a bus 504. An input/output (I/O) interface 505 is also connected to the bus 504.

The following apparatuses may be connected to the I/O interface 505: an input device 506 such as a touch screen, a touchpad, a keyboard, a mouse, a camera, a microphone, an accelerometer, and a gyroscope; an output device 507 such as a liquid crystal display (LCD), a loudspeaker, and a vibrator; a storage device 508 such as a magnetic tape, and a hard disk drive; and a communication device 509. The communication device 509 may allow the electronic apparatus 500 to wireless-communicate or wire-communicate with other devices so as to exchange data. Although FIG. 8 shows the electronic apparatus 500 with various apparatuses, it should be understood that it is not required to implement or possess all the apparatuses shown. Alternatively, it may implement or possess the more or less apparatuses.

In particular, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication device 509, or installed from the storage device 508, or installed from ROM 502. When the computer program is executed by the processing device 501, the above functions defined in the method in the embodiments of the present disclosure are executed.

The names of messages or information exchanged between multiple devices in the embodiments of the present disclosure are only for illustrative purposes, and are not intended to limit the scope of these messages or information.

The electronic apparatus provided in the present embodiment and the image cropping method provided in the above embodiment belong to the same inventive concept. Technical details not described in the present embodiment can be found in the above embodiment, and the present embodiment has the same beneficial effects as the above embodiment.

The embodiments of the present disclosure provide a computer storage medium, on which a computer program is stored, which, when executed by a processor, realizes the image cropping method provided in the above embodiment.

The above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local region network (“LAN”), a wide region network (“WAN”), an internet work (such as the Internet), and an end-to-end network (such as an ad hoc end-to-end network), as well as any currently known or future-developed networks.

The above-described computer-readable medium may be included in the above-described electronic apparatus, or may also exist alone without being assembled into the electronic apparatus.

The above-described computer-readable medium carries one or more programs that, when executed by the electronic apparatus, cause the electronic apparatus to: acquire an image to be cropped, and determine a target cropping object in the image to be cropped and image cropping parameters corresponding to the image to be cropped, the image cropping parameters including a first area proportion threshold of the target cropping object in a target cropping image; process the image to be cropped, determine a bounding box corresponding to the target cropping object in the image to be cropped, and determine box center point information of the bounding box; determine region center point information based on the box center point information, and determine a preliminary cropping region corresponding to the image to be cropped based on the region center point information and the first area proportion threshold; and determine a target cropping region corresponding to the image to be cropped based on a relative position relationship between the preliminary cropping region and the image to be cropped, and determine the target cropping image corresponding to the image to be cropped based on the target cropping region.

The computer program code for executing the operation of the present disclosure may be written in one or more programming languages or combinations thereof, the above programming language includes but not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The units involved in the embodiments of the disclosure can be realized by software or hardware. In certain cases, the name of a unit does not constitute a limitation on the unit itself. For example, the first acquisition unit can also be described as “a unit that acquires at least two Internet protocol addresses”.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, [example 1] provides an image cropping method, the method includes:

acquiring an image to be cropped, and determining a target cropping object in the image to be cropped and image cropping parameters corresponding to the image to be cropped, the image cropping parameters comprising a first area proportion threshold of the target cropping object in a target cropping image;

processing the image to be cropped, determining a bounding box corresponding to the target cropping object in the image to be cropped, and determining box center point information of the bounding box;

determining region center point information based on the box center point information, and determining a preliminary cropping region corresponding to the image to be cropped based on the region center point information and the first area proportion threshold; and

determining a target cropping region corresponding to the image to be cropped based on a relative position relationship between the preliminary cropping region and the image to be cropped, and determining the target cropping image corresponding to the image to be cropped based on the target cropping region.

According to one or more embodiments of the present disclosure, [example 2] provides the method according to [example 1], and further includes:

Optionally, the image cropping parameters comprise a target image aspect ratio corresponding to the target cropping image obtained by cropping the image to be cropped; and

the determining region center point information based on the box center point information, and determining a preliminary cropping region corresponding to the image to be cropped based on the region center point information and the first area proportion threshold comprises:

determining the region center point information based on the box center point information, and determining the preliminary cropping region corresponding to the image to be cropped based on the region center point information, the first area proportion threshold and the target image aspect ratio.

According to one or more embodiments of the present disclosure, [example 3] provides the method according to [example 1], and further includes:

Optionally, the determining a preliminary cropping region corresponding to the image to be cropped based on the region center point information and the first area proportion threshold comprises:

determining an original area proportion of the target cropping object in the target cropping image based on a bounding area of the bounding box and an image area of the image to be cropped; and

in response to the original area proportion being less than a preset second area proportion threshold, determining the preliminary cropping region corresponding to the image to be cropped based on the region center point information and the first area proportion threshold.

According to one or more embodiments of the present disclosure, [example 4] provides the method according to [example 3], and further includes:

Optionally, the image cropping parameters comprise a target image aspect ratio corresponding to the target cropping image obtained by cropping the image to be cropped; and

after determining the original area proportion of the target cropping object in the target cropping image based on the bounding area of the bounding box and the image area of the image to be cropped, the method further comprises:

in response to the original area proportion being greater than or equal to the preset second area proportion threshold, determining the target cropping region corresponding to the image to be cropped based on an original image aspect ratio of the image to be cropped and the target image aspect ratio, and determining the target cropping image corresponding to the image to be cropped based on the target cropping region.

According to one or more embodiments of the present disclosure, [example 5] provides the method according to [example 1], and further includes:

Optionally, the acquiring an image to be cropped, and determining a target cropping object corresponding to the image to be cropped and image cropping parameters corresponding to the image to be cropped comprises:

in response to an effect trigger operation for a target effect, acquiring the image to be cropped, determining an effect action object in the image to be cropped, taking the effect action object as the target cropping object, and acquiring preset image cropping parameters corresponding to the target effect as the image cropping parameters corresponding to the image to be cropped.

According to one or more embodiments of the present disclosure, [example 6] provides the method according to [example 1], and further includes:

Optionally, the acquiring an image to be cropped, and determining a target cropping object corresponding to the image to be cropped and image cropping parameters corresponding to the image to be cropped comprises:

displaying an image cropping interface, the image cropping interface comprising image configuration items and cropping parameter configuration items;

in response to an image configuration trigger operation for the image configuration items, displaying image configuration parameters corresponding to the image configuration items;

in response to a cropping configuration trigger operation for the cropping parameter configuration items, displaying cropping configuration parameters corresponding to the cropping parameter configuration items, the cropping configuration parameters comprising at least one of cropping object configuration parameters, an area proportion threshold of the target cropping object in the target cropping image, and a target image aspect ratio corresponding to the target cropping image obtained by cropping the image to be cropped; and

in response to a cropping execution trigger operation, acquiring the image to be cropped based on the image configuration parameters, and acquiring the target cropping object corresponding to the image to be cropped and the image cropping parameters corresponding to the image to be cropped based on the cropping configuration parameters.

According to one or more embodiments of the present disclosure, [example 7] provides the method according to [example 1], and further includes:

Optionally, the determining a target cropping region corresponding to the image to be cropped based on a relative position relationship between the preliminary cropping region and the image to be cropped comprises:

in response to the relative position relationship between the preliminary cropping region and the image to be cropped being that the preliminary cropping region is located inside the image to be cropped, taking the preliminary cropping region as the target cropping region corresponding to the image to be cropped; and/or,

in response to the relative position relationship between the preliminary cropping region and the image to be cropped being that at least part of the preliminary cropping region is located outside the image to be cropped, adjusting the preliminary cropping region to the inside of the image to be cropped to obtain the target cropping region corresponding to the image to be cropped.

According to one or more embodiments of the present disclosure, [example 8] provides the method according to [example 7], and further includes:

Optionally, the adjusting the preliminary cropping region to the inside of the image to be cropped to obtain the target cropping region corresponding to the image to be cropped comprises:

determining region boundaries of the preliminary cropping region and image boundaries of the image to be cropped;

traversing each of the region boundaries, taking a region boundary outside the image boundaries as a boundary to be processed, and taking a region boundary opposite the boundary to be processed as a reference boundary; and

based on a relative position relationship between the boundary to be processed, an image boundary on the same side as the boundary to be processed, the reference boundary and an image boundary on the same side as the reference boundary, adjusting the preliminary cropping region to obtain the target cropping region corresponding to the image to be cropped.

According to one or more embodiments of the present disclosure, [example 9] provides the method according to [example 8], and further includes:

Optionally, the based on a relative position relationship between the boundary to be processed, an image boundary on the same side as the boundary to be processed, the reference boundary and an image boundary on the same side as the reference boundary, adjusting the preliminary cropping region to obtain the target cropping region corresponding to the image to be cropped comprises:

based on first relative position information between the boundary to be processed and the image boundary on the same side as the boundary to be processed, determining a target moving distance of the preliminary cropping region from a side corresponding to the boundary to be processed to the reference boundary;

according to second relative position information between the reference boundary and the image boundary on the same side as the reference boundary, determining a maximum moving distance of the preliminary cropping region; and

based on a minimum moving distance between the target moving distance and the maximum moving distance, moving the preliminary cropping region towards the reference boundary, and determining the target cropping region corresponding to the image to be cropped based on the preliminary cropping region as moved.

According to one or more embodiments of the present disclosure, [example 10] provides the method according to [example 9], and further includes:

Optionally, the determining the target cropping region corresponding to the image to be cropped based on the preliminary cropping region as moved comprises:

in response to the target moving distance being greater than the maximum moving distance, based on third relative position information between the boundary to be processed after moving and the image boundary on the same side with the boundary to be processed, determining a target scaling ratio corresponding to a region boundary adjacent to the boundary to be processed;

scaling the preliminary cropping region as moved based on the target scaling ratio, so that the boundary to be processed is located inside the image to be cropped;

and

determining the target cropping region corresponding to the image to be cropped based on the boundary to be processed after scaling.

According to one or more embodiments of the present disclosure, [example 11] provides the method according to [example 1], and further includes:

the determining image cropping parameters corresponding to the image to be cropped comprises:

acquiring the first area proportion threshold corresponding to the target cropping object based on target object parameters associated with the target cropping object, the target object parameters comprising at least one of a number of a plurality of target cropping objects in the image to be cropped, an average value of area proportions of each of the plurality of target cropping objects in the image to be cropped, and distances between the plurality of target cropping objects.

According to one or more embodiments of the present disclosure, [example 12] provides the method according to [example 1], and further includes:

Optionally, the determining region center point information based on the box center point information comprises:

in response to the box center point information matching coordinate information of the image to be cropped, taking the box center point information as the region center point information; and

in response to the box center point information of the bounding box not matching the coordinate information of the image to be cropped, transforming coordinate information of the box center point information based on the coordinate information of the image to be cropped, and taking the coordinate information after transforming of the box center point information as the region center point information.

According to one or more embodiments of the present disclosure, [example 13] provides the method according to [example 1], and further includes:

Optionally, the determining the target cropping image corresponding to the image to be cropped based on the target cropped region comprises:

for each pixel in the target cropping region, performing sampling based on coordinate information of the pixel in the image to be cropped, and performing image rendering based on sampled pixel values, so as to obtain the target cropping image corresponding to the image to be cropped.

According to one or more embodiments, [example 14] provides an image cropping device, the device includes:

an image cropping parameter determination module configured to acquire an image to be cropped, and determine a target cropping object in the image to be cropped and image cropping parameters corresponding to the image to be cropped, the image cropping parameters comprising a first area proportion threshold of the target cropping object in a target cropping image;

an object bounding box determination module configured to process the image to be cropped, determine a bounding box corresponding to the target cropping object in the image to be cropped, and determine box center point information of the bounding box;

a preliminary cropping region determination module configured to determine region center point information based on the box center point information, and determine a preliminary cropping region corresponding to the image to be cropped based on the region center point information and the first area proportion threshold; and

a target cropping image determination module configured to determine a target cropping region corresponding to the image to be cropped based on a relative position relationship between the preliminary cropping region and the image to be cropped, and determine the target cropping image corresponding to the image to be cropped based on the target cropping region.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. An image cropping method, comprising:
acquiring an image to be cropped, and determining a target cropping object in the image to be cropped and image cropping parameters corresponding to the image to be cropped, the image cropping parameters comprising a first area proportion threshold of the target cropping object in a target cropping image;
processing the image to be cropped, determining a bounding box corresponding to the target cropping object in the image to be cropped, and determining box center point information of the bounding box;
determining region center point information based on the box center point information, and determining a preliminary cropping region corresponding to the image to be cropped based on the region center point information and the first area proportion threshold; and
determining a target cropping region corresponding to the image to be cropped based on a relative position relationship between the preliminary cropping region and the image to be cropped, and determining the target cropping image corresponding to the image to be cropped based on the target cropping region.

2. The image cropping method according to claim 1, wherein the image cropping parameters comprise a target image aspect ratio corresponding to the target cropping image obtained by cropping the image to be cropped; and
the determining region center point information based on the box center point information, and determining a preliminary cropping region corresponding to the image to be cropped based on the region center point information and the first area proportion threshold comprises:
determining the region center point information based on the box center point information, and determining the preliminary cropping region corresponding to the image to be cropped based on the region center point information, the first area proportion threshold and the target image aspect ratio.

3. The image cropping method according to claim 1, wherein the determining a preliminary cropping region corresponding to the image to be cropped based on the region center point information and the first area proportion threshold comprises:
determining an original area proportion of the target cropping object in the target cropping image based on a bounding area of the bounding box and an image area of the image to be cropped; and
in response to the original area proportion being less than a preset second area proportion threshold, determining the preliminary cropping region corresponding to the image to be cropped based on the region center point information and the first area proportion threshold.

4. The image cropping method according to claim 3, wherein the image cropping parameters comprise a target image aspect ratio corresponding to the target cropping image obtained by cropping the image to be cropped; and
after determining the original area proportion of the target cropping object in the target cropping image based on the bounding area of the bounding box and the image area of the image to be cropped, the method further comprises:
in response to the original area proportion being greater than or equal to the preset second area proportion threshold, determining the target cropping region corresponding to the image to be cropped based on an original image aspect ratio of the image to be cropped and the target image aspect ratio, and determining the target cropping image corresponding to the image to be cropped based on the target cropping region.

5. The image cropping method according to claim 1, wherein the acquiring an image to be cropped, and determining a target cropping object corresponding to the image to be cropped and image cropping parameters corresponding to the image to be cropped comprises:
in response to an effect trigger operation for a target effect, acquiring the image to be cropped, determining an effect action object in the image to be cropped, taking the effect action object as the target cropping object, and acquiring preset image cropping parameters corresponding to the target effect as the image cropping parameters corresponding to the image to be cropped.

6. The image cropping method according to claim 1, wherein the acquiring an image to be cropped, and determining a target cropping object corresponding to the image to be cropped and image cropping parameters corresponding to the image to be cropped comprises:
displaying an image cropping interface, the image cropping interface comprising image configuration items and cropping parameter configuration items;
in response to an image configuration trigger operation for the image configuration items, displaying image configuration parameters corresponding to the image configuration items;
in response to a cropping configuration trigger operation for the cropping parameter configuration items, displaying cropping configuration parameters corresponding to the cropping parameter configuration items, the cropping configuration parameters comprising at least one of cropping object configuration parameters, an area proportion threshold of the target cropping object in the target cropping image, and a target image aspect ratio corresponding to the target cropping image obtained by cropping the image to be cropped; and
in response to a cropping execution trigger operation, acquiring the image to be cropped based on the image configuration parameters, and acquiring the target cropping object corresponding to the image to be cropped and the image cropping parameters corresponding to the image to be cropped based on the cropping configuration parameters.

7. The image cropping method according to claim 1, wherein the determining a target cropping region corresponding to the image to be cropped based on a relative position relationship between the preliminary cropping region and the image to be cropped comprises:
in response to the relative position relationship between the preliminary cropping region and the image to be cropped being that the preliminary cropping region is located inside the image to be cropped, taking the preliminary cropping region as the target cropping region corresponding to the image to be cropped; and/or,
in response to the relative position relationship between the preliminary cropping region and the image to be cropped being that at least part of the preliminary cropping region is located outside the image to be cropped, adjusting the preliminary cropping region to the inside of the image to be cropped to obtain the target cropping region corresponding to the image to be cropped.

8. The image cropping method according to claim 7, wherein the adjusting the preliminary cropping region to the inside of the image to be cropped to obtain the target cropping region corresponding to the image to be cropped comprises:
determining region boundaries of the preliminary cropping region and image boundaries of the image to be cropped;
traversing each of the region boundaries, taking a region boundary outside the image boundaries as a boundary to be processed, and taking a region boundary opposite the boundary to be processed as a reference boundary; and
based on a relative position relationship between the boundary to be processed, an image boundary on the same side as the boundary to be processed, the reference boundary and an image boundary on the same side as the reference boundary, adjusting the preliminary cropping region to obtain the target cropping region corresponding to the image to be cropped.

9. The image cropping method according to claim 8, wherein the based on a relative position relationship between the boundary to be processed, an image boundary on the same side as the boundary to be processed, the reference boundary and an image boundary on the same side as the reference boundary, adjusting the preliminary cropping region to obtain the target cropping region corresponding to the image to be cropped comprises:
based on first relative position information between the boundary to be processed and the image boundary on the same side as the boundary to be processed, determining a target moving distance of the preliminary cropping region from a side corresponding to the boundary to be processed to the reference boundary;
according to second relative position information between the reference boundary and the image boundary on the same side as the reference boundary, determining a maximum moving distance of the preliminary cropping region; and
based on a minimum moving distance between the target moving distance and the maximum moving distance, moving the preliminary cropping region towards the reference boundary, and determining the target cropping region corresponding to the image to be cropped based on the preliminary cropping region as moved.

10. The image cropping method according to claim 9, wherein the determining the target cropping region corresponding to the image to be cropped based on the preliminary cropping region as moved comprises:
in response to the target moving distance being greater than the maximum moving distance, based on third relative position information between the boundary to be processed after moving and the image boundary on the same side with the boundary to be processed, determining a target scaling ratio corresponding to a region boundary adjacent to the boundary to be processed;
scaling the preliminary cropping region as moved based on the target scaling ratio, so that the boundary to be processed is located inside the image to be cropped; and
determining the target cropping region corresponding to the image to be cropped based on the boundary to be processed after scaling.

11. The image cropping method according to claim 1, wherein the determining image cropping parameters corresponding to the image to be cropped comprises:
acquiring the first area proportion threshold corresponding to the target cropping object based on target object parameters associated with the target cropping object, the target object parameters comprising at least one of a number of a plurality of target cropping objects in the image to be cropped, an average value of area proportions of each of the plurality of target cropping objects in the image to be cropped, and distances between the plurality of target cropping objects.

12. The image cropping method according to claim 1, wherein the determining region center point information based on the box center point information comprises:
in response to the box center point information matching coordinate information of the image to be cropped, taking the box center point information as the region center point information; and
in response to the box center point information of the bounding box not matching the coordinate information of the image to be cropped, transforming coordinate information of the box center point information based on the coordinate information of the image to be cropped, and taking the coordinate information after transforming of the box center point information as the region center point information.

13. The image cropping method according to claim 1, wherein the determining the target cropping image corresponding to the image to be cropped based on the target cropped region comprises:
for each pixel in the target cropping region, performing sampling based on coordinate information of the pixel in the image to be cropped, and performing image rendering based on sampled pixel values, so as to obtain the target cropping image corresponding to the image to be cropped.

14. An image cropping device, comprising:
an image cropping parameter determination module configured to acquire an image to be cropped, and determine a target cropping object in the image to be cropped and image cropping parameters corresponding to the image to be cropped, the image cropping parameters comprising a first area proportion threshold of the target cropping object in a target cropping image;
an object bounding box determination module configured to process the image to be cropped, determine a bounding box corresponding to the target cropping object in the image to be cropped, and determine box center point information of the bounding box;
a preliminary cropping region determination module configured to determine region center point information based on the box center point information, and determine a preliminary cropping region corresponding to the image to be cropped based on the region center point information and the first area proportion threshold; and
a target cropping image determination module configured to determine a target cropping region corresponding to the image to be cropped based on a relative position relationship between the preliminary cropping region and the image to be cropped, and determine the target cropping image corresponding to the image to be cropped based on the target cropping region.

15. An electronic apparatus, comprising:
one or more processors; and
a memory configured to store one or more programs, wherein
the one or more programs, when executed by the one or more processors, cause the one or more processors to:
acquire an image to be cropped, and determine a target cropping object in the image to be cropped and image cropping parameters corresponding to the image to be cropped, the image cropping parameters comprising a first area proportion threshold of the target cropping object in a target cropping image;
process the image to be cropped, determine a bounding box corresponding to the target cropping object in the image to be cropped, and determine box center point information of the bounding box;
determine region center point information based on the box center point information, and determine a preliminary cropping region corresponding to the image to be cropped based on the region center point information and the first area proportion threshold; and
determine a target cropping region corresponding to the image to be cropped based on a relative position relationship between the preliminary cropping region and the image to be cropped, and determine the target cropping image corresponding to the image to be cropped based on the target cropping region.

16. The electronic apparatus according to claim 15, wherein the image cropping parameters comprise a target image aspect ratio corresponding to the target cropping image obtained by cropping the image to be cropped; and
the one or more programs, when executed by the one or more processors, cause the one or more processors to determine the region center point information based on the box center point information, and determine the preliminary cropping region corresponding to the image to be cropped based on the region center point information, the first area proportion threshold and the target image aspect ratio.

17. The electronic apparatus according to claim 15, wherein the one or more programs, when executed by the one or more processors, cause the one or more processors to determine an original area proportion of the target cropping object in the target cropping image based on a bounding area of the bounding box and an image area of the image to be cropped; and
in response to the original area proportion being less than a preset second area proportion threshold, determine the preliminary cropping region corresponding to the image to be cropped based on the region center point information and the first area proportion threshold.

18. The electronic apparatus according to claim 17, wherein the image cropping parameters comprise a target image aspect ratio corresponding to the target cropping image obtained by cropping the image to be cropped; and
after determining the original area proportion of the target cropping object in the target cropping image based on the bounding area of the bounding box and the image area of the image to be cropped, the one or more processors are configured to:
in response to the original area proportion being greater than or equal to the preset second area proportion threshold, determine the target cropping region corresponding to the image to be cropped based on an original image aspect ratio of the image to be cropped and the target image aspect ratio, and determine the target cropping image corresponding to the image to be cropped based on the target cropping region.

19. The electronic apparatus according to claim 15, wherein the acquiring an image to be cropped, and determining a target cropping object corresponding to the image to be cropped and image cropping parameters corresponding to the image to be cropped comprises:
in response to an effect trigger operation for a target effect, acquiring the image to be cropped, determining an effect action object in the image to be cropped, taking the effect action object as the target cropping object, and acquiring preset image cropping parameters corresponding to the target effect as the image cropping parameters corresponding to the image to be cropped.

20. A storage medium containing computer-executable instructions, wherein the computer-executable instructions, when executed by a computer processor, perform the image cropping method according to claim 1.
